(19) United States
(12) Patent Application Publication
(10) Pub. No.: US 2017/0054542 A1
(43) Pub. Date: Feb. 23, 2017

(54) SOUNDING DESIGN FOR CHANNEL FEEDBACK

(71) Applicant: QUALCOMM Incorporated, San Diego, CA (US)

(72) Inventors: Sameer VERMANI, San Diego, CA (US); Bin TIAN, San Diego, CA (US); Jialing Li CHEN, San Diego, CA (US); Arjun BHARADWAJ, Poway, CA (US); Youhan KIM, San Jose, CA (US)

(21) Appl. No.: 15/240,066

(22) Filed: Aug. 18, 2016

Related U.S. Application Data
(60) Provisional application No. 62/305,455, filed on Mar. 8, 2016.
(60) Provisional application No. 62/303,188, filed on Mar. 3, 2016.
(60) Provisional application No. 62/296,774, filed on Feb. 18, 2016.
(60) Provisional application No. 62/268,475, filed on Dec. 16, 2015.
(60) Provisional application No. 62/250,425, filed on Nov. 3, 2015.
(60) Provisional application No. 62/216,323, filed on Sep. 9, 2015.
(60) Provisional application No. 62/207,326, filed on Aug. 19, 2015.

(51) Int. Cl. H04L 5/00

(52) U.S. Cl. CPC H04L 5/0057; H04L 5/006; H04L 5/0044

(57) ABSTRACT

Aspects of the present disclosure provide techniques for sounding procedures using frames with some portions that use relatively long symbol durations. Certain aspects of the present disclosure provide a method that may be performed by an access point. The method generally includes generating one or more frames, collectively having one or more training fields allowing one or more stations to calculate channel information and an indication of one or more feedback parameters for the one or more stations to use for generating the channel information; transmitting the one or more frames; and receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

### CROSS-REFERENCE TO RELATED APPLICATION & PRIORITY CLAIM

This application claims benefit of and priority to U.S. Provisional Patent Application Ser. No. 62/207,326, filed Aug. 19, 2015, application Ser. No. 62/216,323, filed Sep. 9, 2015, application Ser. No. 62/250,425, filed Nov. 3, 2015, application Ser. No. 62/268,475, filed Dec. 16, 2015, application Ser. No. 62/296,774, filed Feb. 18, 2016, application Ser. No. 62/303,188, filed Mar. 3, 2016, and Application Ser. No. 62/305,455, filed Mar. 8, 2016, all of which are herein incorporated by reference in their entirety for all applicable purposes.

### BACKGROUND

Field of the Disclosure

Certain aspects of the present disclosure generally relate to wireless communications and, more particularly, to sounding procedures and parameters for generating and feeding back channel information.

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is being developed by the Institute of Electrical and Electronics Engineers (IEEE) 802.11ax task force. This development is driven by the desire to combine the spatial diversity gains achieved with multiple in-multiple out transmissions using multiple antennas with orthogonal frequency division multiplexing schemes, with subsets of frequencies assigned to different users.

To take advantage of these schemes, channel information across both spatial streams and different frequency regions may be fed back from stations to allow an access point to optimize performance. This feedback may be obtained through a sounding procedure, whereby a station generates channel information based on training fields in packets transmitted from the access point. During the sounding procedure, it may be desirable to limit the amount of feedback while still ensuring adequate performance.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure provide a method for wireless communications that may be performed by an access point. The method generally includes generating one or more frames, collectively having one or more training fields allowing one or more stations to calculate channel information and an indication of one or more feedback parameters for the one or more stations to use for generating the channel information; transmitting the one or more frames; and receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

Aspects of the present disclosure provide an apparatus for wireless communications that may be performed by an access point. The apparatus generally includes means for generating one or more frames, collectively having one or more training fields allowing one or more stations to calculate channel information and an indication of one or more feedback parameters for the one or more stations to use for generating the channel information; means for transmitting the one or more frames; and means for receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

Aspects of the present disclosure provide an apparatus for wireless communications that may be performed by an access point. The apparatus generally includes at least one processor configured to generate one or more frames, collectively having one or more training fields allowing one or more stations to calculate channel information and an indication of one or more feedback parameters for the one or more stations to use for generating the channel information; transmit the one or more frames; and receive channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units; and a memory coupled with the at least one processor.

Aspects of the present disclosure provide a computer readable medium having computer executable code stored thereon for wireless communications that may be performed by an access point. The code generally includes code for generating one or more frames, collectively having one or more training fields allowing one or more stations to calculate channel information and an indication of one or more feedback parameters for the one or more stations to use for generating the channel information; code for transmitting the one or more frames; and code for receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

Aspects of the present disclosure also provide various other methods, apparatuses, and computer readable medium capable of performing the operations described above and herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 is a block diagram illustrating example operations for wireless communications by a transmitting apparatus, in accordance with certain aspects of the present disclosure.

FIG. 5 illustrates an example frame structure with long training fields (LTFs), accordance with certain aspects of the present disclosure.

FIG. 6 illustrates an example reporting structure, in accordance with certain aspects of the present disclosure.

FIG. 7 illustrates an example sounding frame exchange, in accordance with aspects of the present disclosure.

FIG. 8 illustrates an example optimized sounding frame structure, in accordance with aspects of the present disclosure.

FIG. 9 illustrates an example sounding frame exchange, in accordance with aspects of the present disclosure.

FIG. 10 illustrates example performance results using sounding procedures, in accordance with aspects of the present disclosure.

FIGS. 11-14 illustrate example tone plans, in accordance with aspects of the present disclosure.

FIG. 15 illustrates an example tone plan for a training field and a data portion of a frame, in accordance with aspects of the present disclosure.

FIG. 16 illustrates an example announcement frame, in accordance with certain aspects of the present disclosure.

FIG. 16A illustrates an example station information field of the example announcement frame illustrated in FIG. 16, in accordance with certain aspects of the present disclosure.

FIGS. 17 and 18 illustrate an example announcement frame and training frame, in accordance with aspects of the present disclosure.

FIG. 19 is a transmission timeline illustrating an example sounding frame exchange for high efficiency (HE) single user (SU) feedback, in accordance with certain aspects of the present disclosure.

FIG. 20 is a table showing an example order of angles in a Compressed Beamforming Feedback Matrix subfield, in accordance with certain aspects of the present disclosure.

FIG. 21 is a table showing example subfield descriptions for a VHT MIMO Control field, in accordance with certain aspects of the present disclosure.

FIG. 22 is table showing an example VHT Compressed Beamforming frame Action field format, in accordance with certain aspects of the present disclosure.

FIG. 23 is a table showing an example Beamforming Report structure, in accordance with certain aspects of the present disclosure.

FIG. 24 is an example HE NDPA frame format, in accordance with certain aspects of the present disclosure.

FIG. 24A shows example subfields of a Feedback Parameter Control field of HE NDPA frame format shown in FIG. 24, in accordance with certain aspects of the present disclosure.

FIG. 24B-24D show example subfields of a STA Info field of HE NDPA frame format shown in FIG. 24, in accordance with certain aspects of the present disclosure.

FIG. 24E shows example subfields of a Feedback Parameter Control field of HE NDPA frame format shown in FIG. 24, in accordance with certain aspects of the present disclosure.

FIG. 24F shows example subfields of a STA Info field of HE NDPA frame format shown in FIG. 24, in accordance with certain aspects of the present disclosure.

FIG. 24G shows example subfields of a Feedback Parameter Control field of HE NDPA frame format shown in FIG. 24, in accordance with certain aspects of the present disclosure.

FIG. 24H shows example subfields of a STA Info field of HE NDPA frame format shown in FIG. 24, in accordance with certain aspects of the present disclosure.

FIG. 24I is an example HE NDPA frame format, in accordance with certain aspects of the present disclosure.

FIG. 24J shows example subfields of a STA Info field of HE NDPA frame format shown in FIG. 24, in accordance with certain aspects of the present disclosure.

FIG. 24K-24L show example subfields of an HE NDPA frame format, in accordance with certain aspects of the present disclosure.

FIGS. 24M-24O show example subfields of a STA Info field of HE NDPA frame format shown in FIG. 24K, in accordance with certain aspects of the present disclosure.

FIG. 24P shows example subfields of a STA Info field of HE NDPA frame format shown in FIG. 24L, in accordance with certain aspects of the present disclosure.

FIG. 25 is a transmission timeline illustrating an example sounding protocol for partial bandwidth feedback, in accordance with certain aspects of the present disclosure.

FIG. 26 illustrates an example tone plan, in accordance with aspects of the present disclosure.

FIG. 27 is a table showing an example tone plane with RUs having contiguous tones in positive half of HE20, in accordance with certain aspects of the present disclosure.

FIG. 28 is table showing an example tone plan with RUs having contiguous tones in positive half of HE40, in accordance with certain aspects of the present disclosure.

FIG. 29 is table showing an example tone plan with RUs having contiguous tones in positive half of HE80, in accordance with certain aspects of the present disclosure.

FIG. 30 is a table showing an example of 26-tone RUs having a 26-tone segment boundary, in accordance with certain aspects of the present disclosure.

FIG. 31 is a table showing an example of 26-tone RUs having a 28-tone segment boundary, in accordance with certain aspects of the present disclosure.

FIG. 32 is a table showing an example of 26-tone RUs having a 30-tone segment boundary, in accordance with certain aspects of the present disclosure.

FIG. 33 is a table showing an example of 26-tone RUs having a 32-tone segment boundary, in accordance with certain aspects of the present disclosure.

FIG. 34 illustrates an example tone plan, in accordance with aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure generally relate to a sounding procedure whereby multiple stations may feed back channel information to an access point. The channel information, for example, may help the access point in optimizing performance when communicating with the multiple stations. In some cases, the stations may calculate channel information based on long training fields (LTFs) that use normal (1×) or extended symbol durations, such as 2× and 4× high efficiency (HE) LTFs. Resource allocation for such transmissions may be defined by what is commonly referred to as a “tone map” that indicates a number and location of tones to be used for communications between the access point and stations.

In aspects, the sounding feedback can be solicited by the AP based on sounding protocols. In one example, the AP can send one frame to trigger feedback from a single station or from multiple stations. Alternatively, the AP may use multiple frames to trigger feedback from multiple stations. In aspects, the frame used to solicit the sounding feedback may include training fields for the station(s) to calculate the sounding feedback and/or information indicating how the feedback should be calculated and/or fed back. For example, the indication of feedback bandwidth may be in the announcement frame (e.g., the null data packet announcement (NDPA)). Alternatively, the training fields and/or information can be sent in separate frames from access point. In one example, the information may indicate to use a subsampling factor (N_{g}) of greater than one (e.g., 4 or 16) for the station(s) to use for channel feedback. The information may also indicate the particular tone plans (frequency resources) to be used for channel feed back, which may be depend on the subsampling factor and the NDP bandwidth. For example, the access point may request 26-tone RU channel feedback and indicate a starting and ending tone (e.g., using 7 bits). In aspects, the access point may request partial bandwidth feedback (e.g., less than the NDP bandwidth). In addition to the subsampling factor, the access point may also control other feedback parameters, such as quantization and number of streams (e.g., number of columns in beamforming matrix feedback, N_{c}). Alternatively, in the case of SU feedback, the beamformee (e.g., the station) may control these feedback parameters. The access point may request beamforming matrix information feedback, signal-to-noise ratio (SNR) feedback, and average SNR feedback, or channel quality information (CQI) only feedback. The requested feedback may be per-stream and/or per-tone.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

While aspects may be described herein using terminology commonly associated with 3G and/or 4G wireless technologies, aspects of the present disclosure can be applied in other generation-based communication systems, such as 5G and later, including NR technologies.

### An Example Wireless Communications System

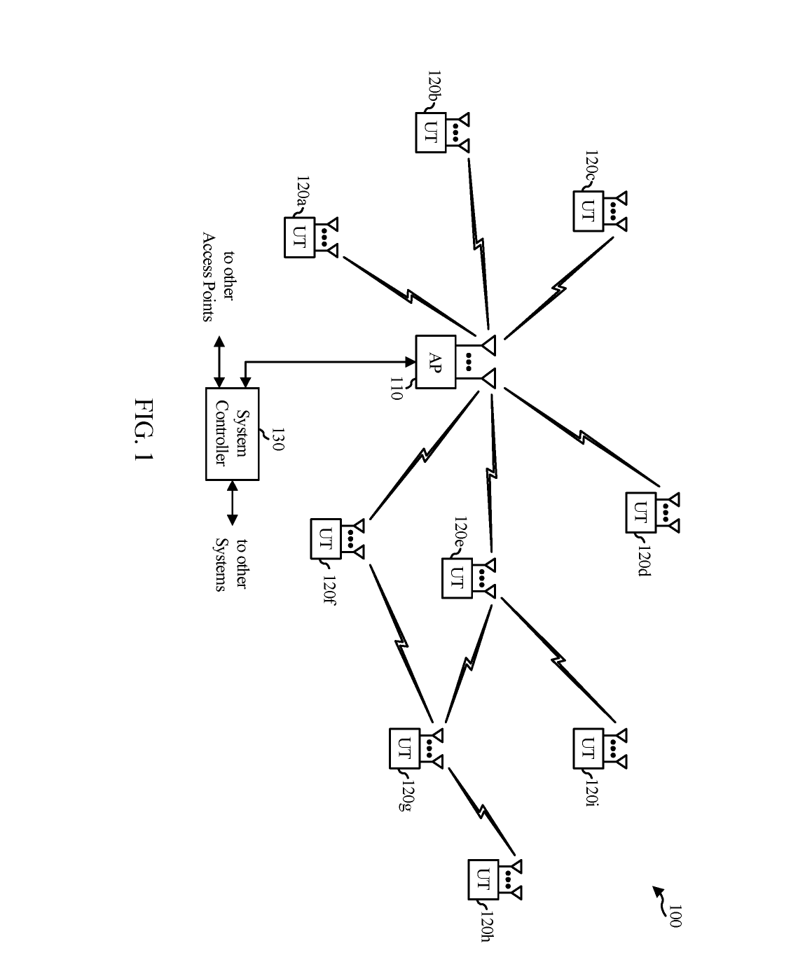

FIG. 1 illustrates a system 100 in which aspects of the disclosure may be performed. For example, the access point 110 may generate one or more frames, collectively having one or more training fields allowing one or more stations 120 to calculate channel information and an indication of one or more feedback parameters for the one or more stations 120 to use for generating the channel information. The access point 110 may receive channel information from at least one of the stations 120 calculated, in accordance with the one or more feedback parameters, for a corresponding one or more reporting units based on the one or more training fields, wherein the channel information is received via a report containing a plurality of channel information parameters for each of the one or more reporting units.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

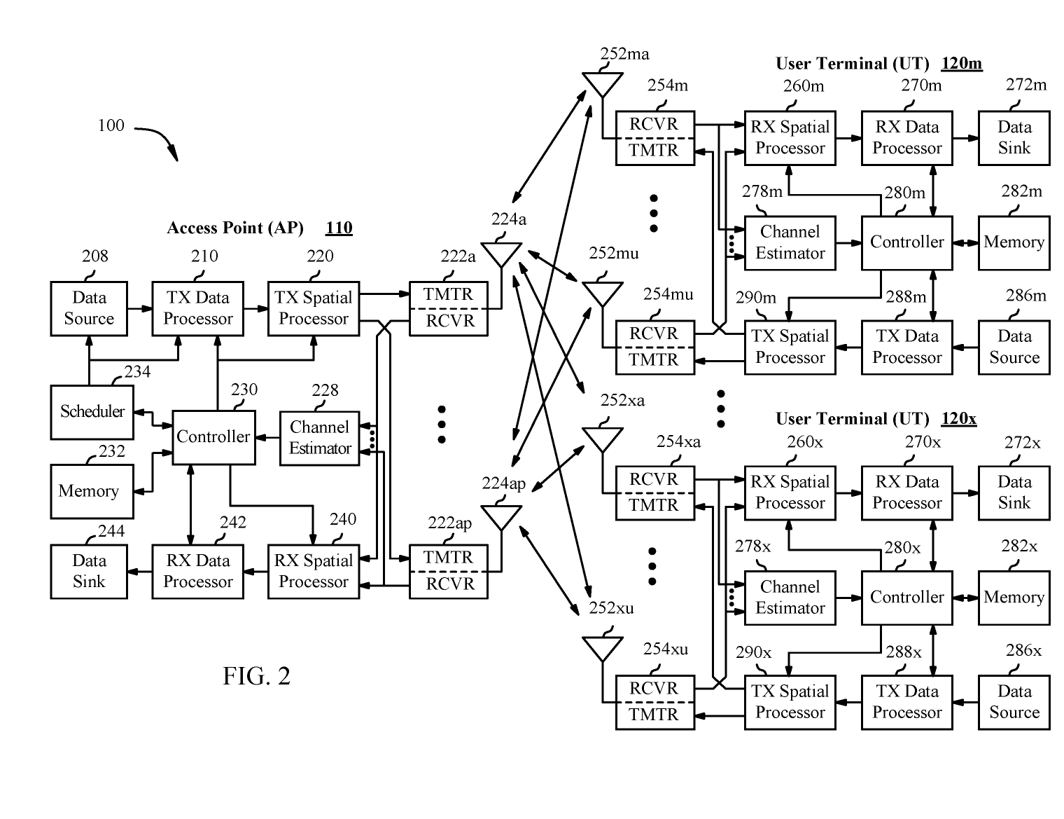

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, and/or processors 210, 220, 240, 242, of the AP 110, and/or controller 230 or antenna 252, Tx/Rx 254, processors 260, 270, 288, and 290, and/or controller 280 of UT 120 may be used to perform the operations described herein.

FIG. 2 illustrates a block diagram of access point 110 and two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

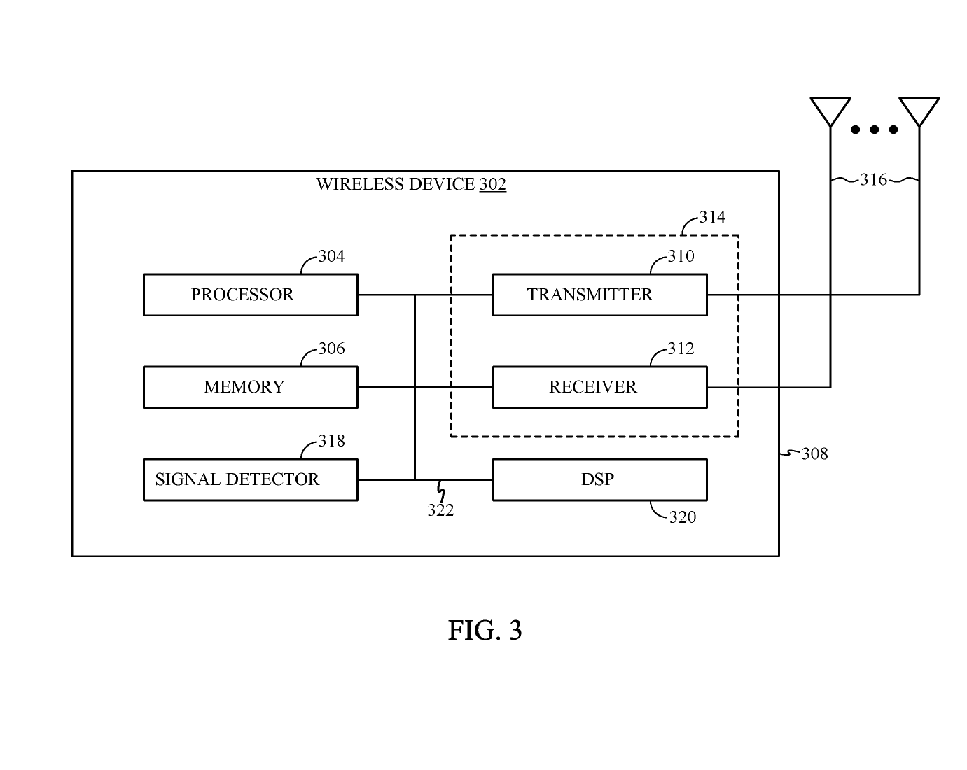

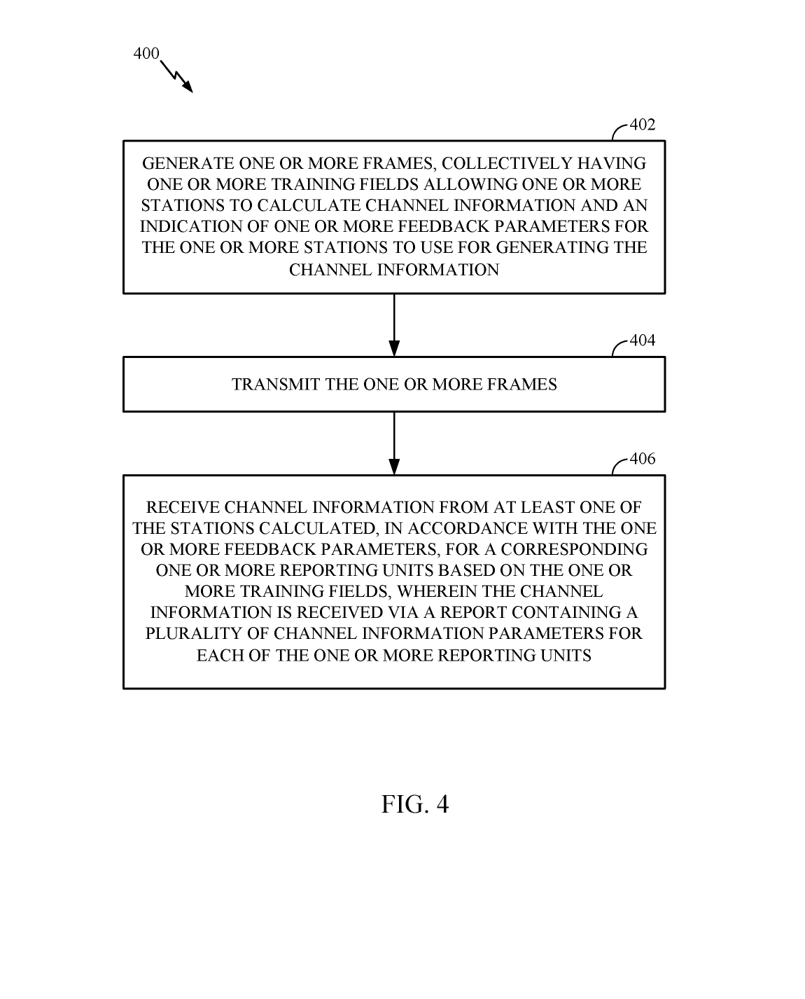

FIG. 3 illustrates various components that may be utilized in a wireless device 302 that may be employed within the MIMO system 100. The wireless device 302 is an example of a device that may be configured to implement the various methods described herein. For example, the wireless device may implement operations described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Sounding Design for Channel Feedback

Aspects of the present disclosure generally relate to a sounding procedure whereby multiple stations may feed back channel information to an access point. The channel information, for example, may help the access point in optimizing performance when communicating with the multiple stations. As will described in more detail herein, the stations may calculate channel information based on long training fields (LTFs) that use normal (1×) or extended symbol durations, such as 2× and 4× high efficiency (HE) LTFs. Resource allocation for such transmissions may be defined by what is commonly referred to as a “tone map” that indicates a number and location of tones to be used for communications between the access point and stations.

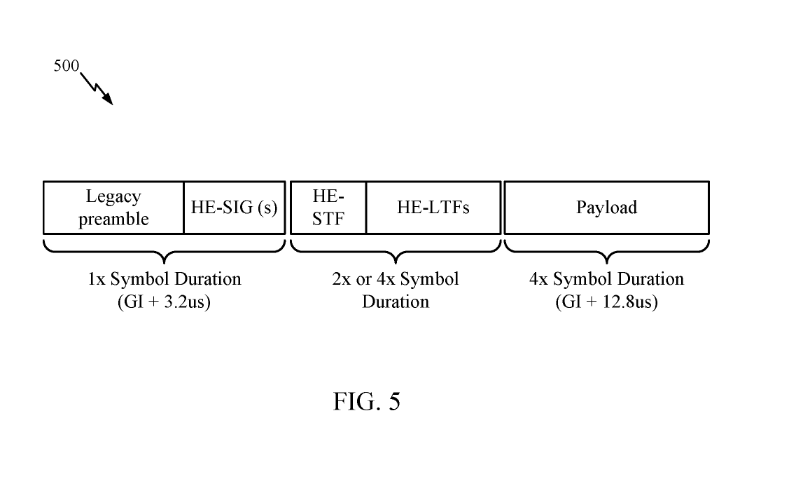

Further, as will be described in more detail herein, sounding feedback can be solicited by the AP based on sounding protocols. FIG. 5 illustrates a block diagram of example operations 500 for wireless communications by a transmitting apparatus, such as an access point (e.g., AP 110), that allows for sounding feedback, in accordance with certain aspects of the present disclosure.

The operations 400 begin, at 402, by generating one or more frames, collectively having one or more training fields allowing one or more stations to calculate channel information and an indication of one or more feedback parameters for the one or more stations to use for generating the channel information.

At 404, the transmitting device transmits the one or more frames. In one example, the AP can send one frame to trigger feedback from a single station or from multiple stations. Alternatively, the AP may use multiple frame to trigger feedback from multiple stations. In aspects, the frame used to solicit the sounding feedback may include training fields for the station(s) to calculate the sounding feedback and/or information indicating how the feedback should be calculated and/or fed back. For example, the indication of feedback bandwidth may be in the announcement frame (e.g., the null data packet announcement (NDPA)). Alternatively, the training fields and/or information can be sent in separate frames from access point. In one example, the information may indicate to use a subsampling factor (N_{g}) of greater than one (e.g., 4 or 16) for the station(s) to use for channel feedback. The information may also indicate the particular tone plans (frequency resources) to be used for channel feed back, which may be depend on the subsampling factor and the NDP bandwidth. For example, the access point may request 26-tone RU channel feedback and indicate a starting and ending tone (e.g., using 7 bits).

At 406, the transmitting device receives channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units. In aspects, the access point may request partial bandwidth feedback (e.g., less than the NDP bandwidth). In addition to the subsampling factor, the access point may also control other feedback parameters, such as quantization and number of streams (e.g., number of columns in beamforming matrix feedback, N_{c}). Alternatively, in the case of SU feedback, the beamformee (e.g., the station) may control these feedback parameters. The access point may request beamforming matrix information feedback, signal-to-noise ratio (SNR) feedback, and average SNR feedback, or channel quality information (CQI) only feedback. The requested feedback may be per-stream and/or per-tone.

### Example Tone Allocation and Sounding Procedures

As described above, a packet (also referred to as a frame) may be communicated over a wireless medium using a waveform that is modulated over a fixed frequency band during a fixed period of time. The frequency band may be divided into one or more “tones” and the period of time may be divided into one or more “symbols.” As an illustrative non-limiting example, a 20 MHz frequency band may be divided into four 5 MHz tones and an 80 microsecond period may be divided into twenty 4 microsecond symbols. Accordingly, a “tone” may represent a frequency sub-band included in a waveform. A tone may alternately be referred to as a subcarrier. A “tone” may thus be a frequency domain unit. A “symbol” may be a time domain unit representing a duration of time included in the waveform. Thus, the waveform for a wireless packet may thus be visualized as a two-dimensional structure that includes multiple tones (often on a vertical axis in units of frequency) and multiple symbols (on a horizontal axis in units of time).

As an example, a wireless device may receive a packet via a 20 megahertz (MHz) wireless channel (e.g., a channel having 20 MHz bandwidth). The wireless device may perform a 64-point fast Fourier transform (FFT) to determine 64 tones in a waveform of the packet. A subset of the tones may be considered “useable” and the remaining tones may be considered “unusable” (e.g., may be guard tones, direct current (DC) tones, etc.). To illustrate, 56 of the 64 tones may be useable, including 52 data tones and 4 pilot tones. As another example, there may be 48 data tones and 4 pilot tones. It should be noted that the aforementioned channel bandwidths, transforms, and tone plans are for exemplary purposes only. According to alternate embodiments, different channel bandwidths (e.g., 5 MHz, 6 MHz, 6.5 MHz, 40 MHz, 80 MHz, etc.), different transforms (e.g., 256-point FFT, 1024-point FFT, etc.), and/or different tone plans may be used. Additional tone allocation plans are described below.

Aspects of the present disclosure generally provide techniques that an access point may use for receiving feedback from a plurality of stations. The feedback may help the access point optimize communications with the stations via wireless packets that utilize extended symbol durations (e.g., 2× and/or 4× symbol durations).

In some applications, longer symbol durations are used for various portions of a frame. For example, FIG. 5 shows an example packet 500, in which a longer symbol duration (e.g., 2× or 4×) is used for HE-LTFs as well as a subsequent data payload. This symbol duration is longer relative to a reference duration (e.g., a 1× symbol duration used for a legacy preamble portion and/or an HE-SIG field).

Certain standards, such as IEEE 802.11ac, support sounding to get channel state information feedback at a transmitter (e.g., an access point) that communicates to multiple stations using beam-forming. In some cases, the access point may transmit a packet that contains LTFs that stations may use to calculate the channel. Such a packet may be referred to as a null data packet (NDP), as it may not have a data payload portion.

The feedback may include various types of information, such as compressed V-matrix information on all tones or only a sub-sampled number (less than all) of tones, an average SNR per spatial stream, singular value (S) feedback, per (spatial) stream on all or a sub-sampled number of tones. In such cases, the S feedback may be calculated as a delta from the average SNR per spatial stream. The channel feedback for a particular subcarrier (tone or set of tones) may be generated by a station by decomposing the channel matrix H as the product of an orthonormal matrix (V) and a real diagonal matrix (S), where H=USV*(U is a unitary matrix). In this case, feeding back V and S is sufficient.

The process of sub-sampling the feedback may be referred to as tone-grouping. With tone-grouping, one value of V or one value of S may be sent for a “group” of tones based on a “sub-sampling factor” N_{g}. For example, N_{g}=2 means that one V is sent for a group of 2 tones. In some cases, once N_{g} has been chosen for V, a sub-sampling factor for S (N_{g}′) may be determined as N_{g}′=2N_{g}.

In certain systems, (e.g., proposed IEEE 802.11ax systems), the sub-carrier width during the data section of a packet may be four times smaller than in others (such as IEEE 802.11ac systems). In such cases, four times longer (e.g., referred to as 4×) symbol durations may be introduced to keep longer CP durations have manageable overhead.

Aspects of the present disclosure provide techniques for applying tone-grouping to such systems for sounding feedback in such systems. According to certain aspects, the access point can send an indication of resources for each device to use for feeding back the channel information and the channel information feedback may be received on the indicated resources, from the stations.

In some cases, certain tone grouping techniques may be utilized for a sounding procedure to account for systems (e.g., such as 802.11ax systems) that use smaller sub-carrier width (and longer symbol durations). As an example, in some cases a sub-sampling factor for such systems may be equal to or greater than two (N_{g}≧2). In this case, N_{g} may be defined with reference to data tone width, such that N_{g}=4 in systems with 4× symbol duration would mean one out of four data tones is sampled. In this case, the size (amount) of CSI feedback for a given BW with N_{g}=4 for an 802.11ax may be approximately equal the size of CSI feedback for the same BW for N_{g}=1 in an 802.11ac system.

According to certain aspects, the sub-sampling factor for S feedback N_{g}′ (also defined with reference to data tones) may be M*N_{g}, where M can take a value which is greater than equal to 2.

According to certain aspects, various LTF durations may be used in packets (such as NDP packets) containing LTFs for sounding. For example, LTF duration in NDP packets may be less than or equal to 2×. In other words, in some cases, 1× duration may be sufficient from a performance viewpoint. However, in some cases, having a 2×LTF might provide consistency with data packets (that may not currently have 1×LTFs). In some cases 2×LTFs might be needed to provide accurate feedback in outdoor channels which have more frequency selectivity.

According to certain aspects, additional sampling of edge tones may be performed to augment the feedback (e.g., with different subsampling factors used in edge tone regions than in middle tone regions). As an example, with 2×LTFs, a station may feed back channel information with N_{g}=2 at the edges and N_{g}≧2 in the middle tones. In general, the edge tones may refer to tones near guard band regions and/or on both sides of DC tones. As another example, with 1×LTFs, a station may feedback at N_{g}=4 at the edges and N_{g}≧4 in the middle tones.

According to certain aspects, rather than provide feedback for the entire (PPDU) bandwidth, feedback may be based on partial BW. In this case, additional sampling may be performed, as described above for edge tones (with edge tones in this case referring to edge tones of partial BW and not PPDU BW). In some cases, additional tones around DC may not be needed, for example, unless the (partial) band is near the physical DC of the PPDU BW.

In some cases, feedback of channel quality (CQI) only may be used (for different bandwidth parts). In this manner, an AP may be able to gather channel state information and CQI information on parts of the PPDU BW. In some cases, an AP may request only CQI feedback for specified bandwidth parts.

Regardless of the type of feedback, there may be various types of reporting units, such as per-RU based or per sub-band based. Feeding back information on a per-RU basis may present challenges as tone locations for the same size RUs may not be consistent across different PPDU BWs. Further, due to the size of RUs, it may not be possible to divide the PPDU BW into a certain number of RUs of same size (e.g., it may not be possible to divide 80 MHz into 52 tone RU chunks).

On the other hand, with sub-band based reporting it may be possible to divide the bandwidth into constant sized blocks (e.g., 2 MHz or 2.5 MHz wide) and an AP may be able to request the information for a particular block index. In some cases, a single CQI may be requested for multiple of these blocks (e.g., if the smallest block size if 2 MHz, an AP may request information for multiple blocks of that block size).

Regardless of the reporting unit (per-RU or per sub-band), various types of information may be fed back as part of the feedback report. The types of feedback may include V matrix feedback on all or sub-set of the tones of the requested sub-band or RU, average SNR per spatial stream (e.g., as an average taken across the sub-band or RU being requested), S (singular value) feedback on all or sub-set of the tones of the requested sub-band or RU. Reported CQI may include S feedback (per spatial stream) or an average of S across all spatial streams. Reported CQI may also include MCS feedback and reported CQI may be the CQI only for a given number of Eigen modes or spatial streams. In some cases, a station may report the index of a best few sub-bands or best few RUs for the STA, for example, best in terms of channel strength (SNR), signal to interference ratio (SINR), some equivalent metric of channel quality (e.g. an average of S). In some cases, the feedback may include information about interference levels for the sub-band or RU. For example, the feedback may indicate if a certain sub-band/RU is heavily interfered or which sub-bands/RUs have least interference.

In some cases, a feedback report may have parameters listed in a certain order. As an example, a report could list average SNR (across the entire operating band) for each stream, followed by the compressed beamforming (V) matrix for each tone. The same feedback report (or a different feedback report) could then list delta SNR for each tone, in order.

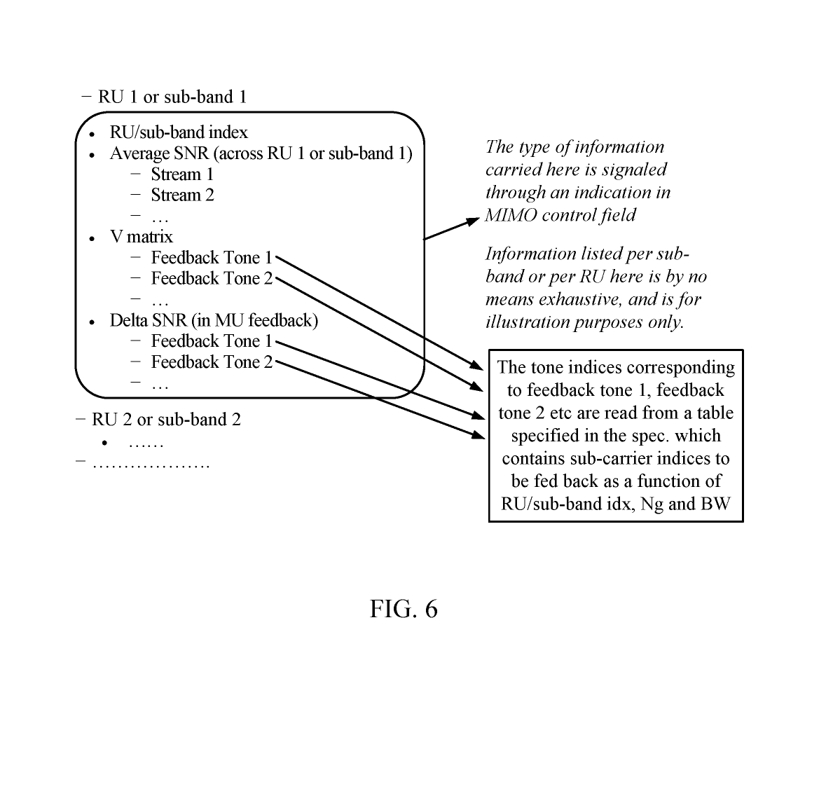

FIG. 6 illustrates an example of a beamforming report structure that may be considered optimized for accommodating partial band feedback. As illustrated, different parameters for a same reporting unit may be grouped together. For example, for a given RU or sub-band, the report may include average SNR (across that RU or sub-band) per stream may be listed, the compressed beamforming (V) matrix for each tone (in the RU or sub-band), and delta SNR for each tone (in the RU or sub-band). Of course, the type of information listed is illustrative only and other types of information or combination of information may be included. In some cases, the particular type of information carried in the report may be signaled (e.g., through an indication in a MIMO control field). In FIG. 6, the tone indices (e.g., corresponding to feedback tone 1, feedback tone 2, etc.) may be read from a table which may contain sub-carrier indices to be fed back as a function of various parameters (such as RU/sub-band index, Ng and BW).

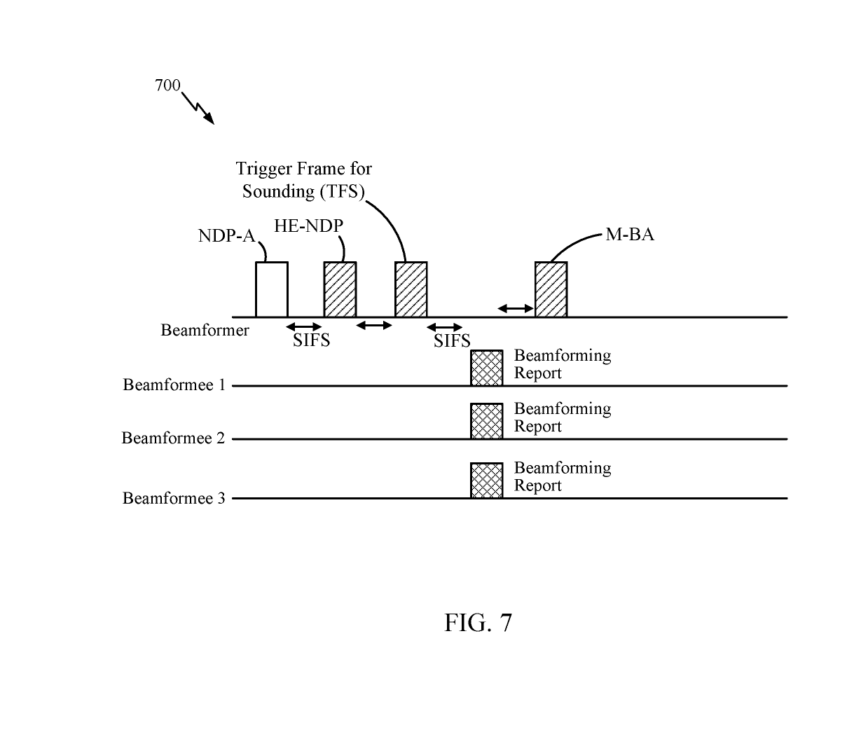

FIG. 7 illustrates an example sounding frame exchange 700, in accordance with aspects of the present disclosure. The frame exchange 700 may be used, for example, when all STAs are of a same type (e.g., all 802.11ax capable STAs) and capable of receiving MU sounding packets. As illustrated, the beamformer (e.g., AP) may begin by sending an NDP announcement (NDP-A), followed by an HE-NDP. The HE-NDP may include LTFs, as described above, that the stations (Beamformees 1-3) can use to calculate channel information. The AP may also send a trigger frame for sounding (TFS) that provides an indication of resources allocated to the stations for sending their beamforming reports. After receiving the reports from the stations, the AP may send a multi-user Block ACK.

FIG. 8 illustrates an example frame exchange in which some of the frames shown in FIG. 7 may be combined. As illustrated, the NDP-A and HE-NDP may be combined into a single frame. As illustrated, information from the NDPA may be included in the HE-SIGB field. In this case, the frame may include an indication (early enough) that the fields of the HE-SIGB are to be re-interpreted for NDPA (as opposed to regular DL MU packets). The station may calculate the channel information based HE-LTFs (e.g., these may serve the same purpose as LTFs in the NDP (a subset of 1×, 2×, and 4×LTFs may be allowed). As illustrated in FIG. 8, the trigger frame (or information normally included in the trigger frame) may also be included in the frame, for example, in the payload.

Relative to the exchange shown in FIG. 7, the format shown in FIG. 8 may save substantial overhead (e.g., by reducing preambles, inter-frame spacing, and the like). Placing the trigger information in the payload may give the stations enough time after HE-LTFs to prepare feedback packet. In some cases, the number of LTFs in the packet may correspond to a higher number of spatial streams than the streams in the payload section. In some cases, placing a MAC trigger frame information in the payload may be a default mode of operation (although a separate MAC trigger frame may also be sent instead).

One disadvantage to the format shown in FIG. 8 is that it may not support certain devices (e.g., “legacy” 802.11ac/n devices). However, FIG. 9 illustrates an example sounding frame exchange that may support legacy and enhanced devices, in accordance with aspects of the present disclosure. In other words, in the illustrated sequence, the NDPA and NDP may be backwards compatible.

The exchange shown in FIG. 9 is divided into different sections (1 through 5), and different aspects of the present disclosure may be based on different combinations of these sections, as follows. Section 1 may be present in many aspects. Section 4 may be present in aspects that include at-least two 11ax STAs. As illustrated, section 4 may be similar to the UL MU procedure. Sections 3 and 5 may also involve more than one beamformee (e.g., more than one pair of poll and “BF report”). If a legacy STA is the first STA in the NDPA, an exchange may involve the following combinations: Section 1, 2, 3, 4, 5; Sections 1, 2, 4, 5; Sections 1, 2, 3, 4; or Sections 1, 2, 4. If legacy STAs go after the enhanced (e.g., 11ax) STAs, the combination of Sections 1, 4, and 5 may be supported.

In some cases, multiple sections such as Section 4 may be present, for example, with each section collecting feedback for a different group of (11ax) STAs. In some cases, the multiple sections may be separated by sections as in Section 5.

As noted above, the format of an LTF may be carefully designed for a sounding packet. For example, for the separate NDP case, a subset of 1×, 2× and 4× LTFs may be allowed. A 1×LTF based NDP may be the same as a previous (e.g. 11ac) NDP. 2× and 4×LTFs may be used for outdoor use-cases and, in some cases, may use the same LTF sequences as in regular data packets or may use different LTF sequences compared to regular data packets (e.g., with some tones nulled out). Further, as noted above, N_{g}=2 or 4 may be used in the middle tones while N_{g}=1 or 2 is used at the edges.

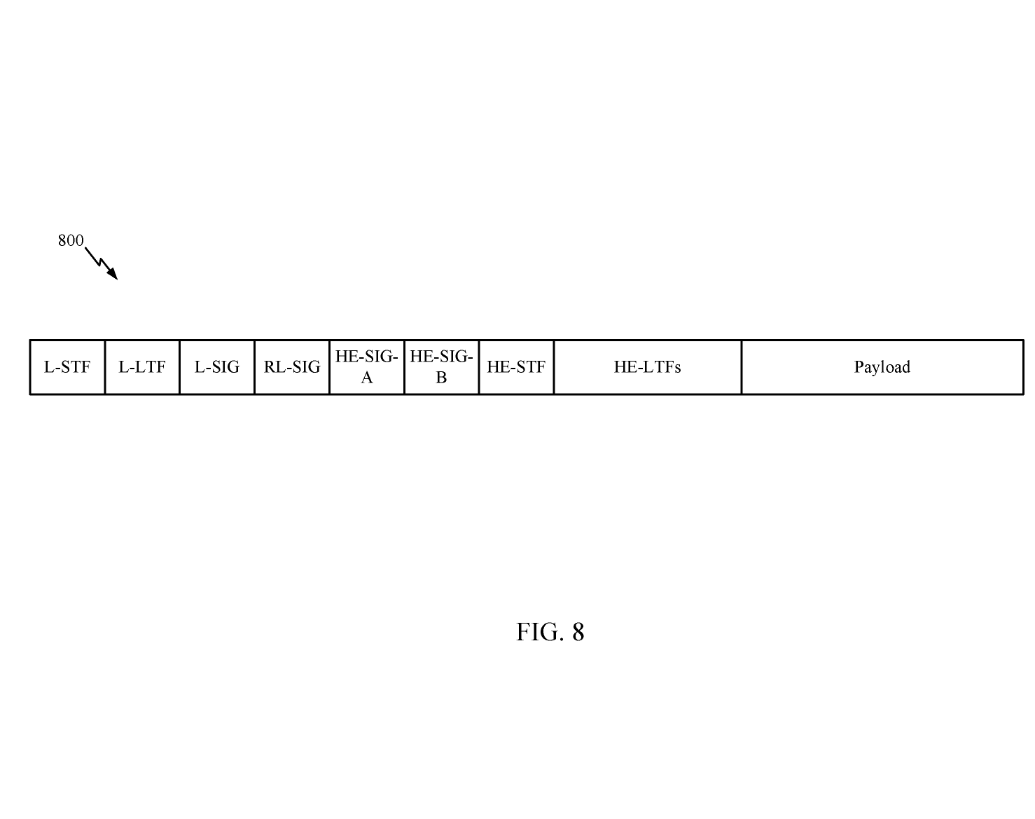

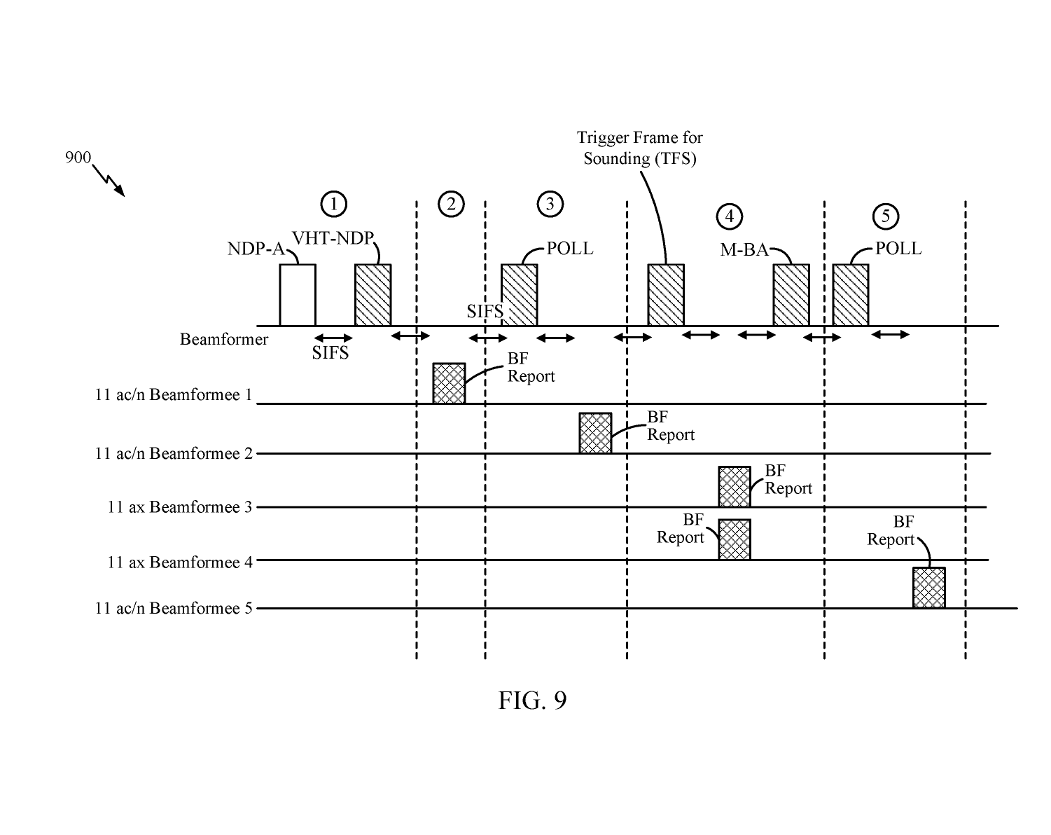

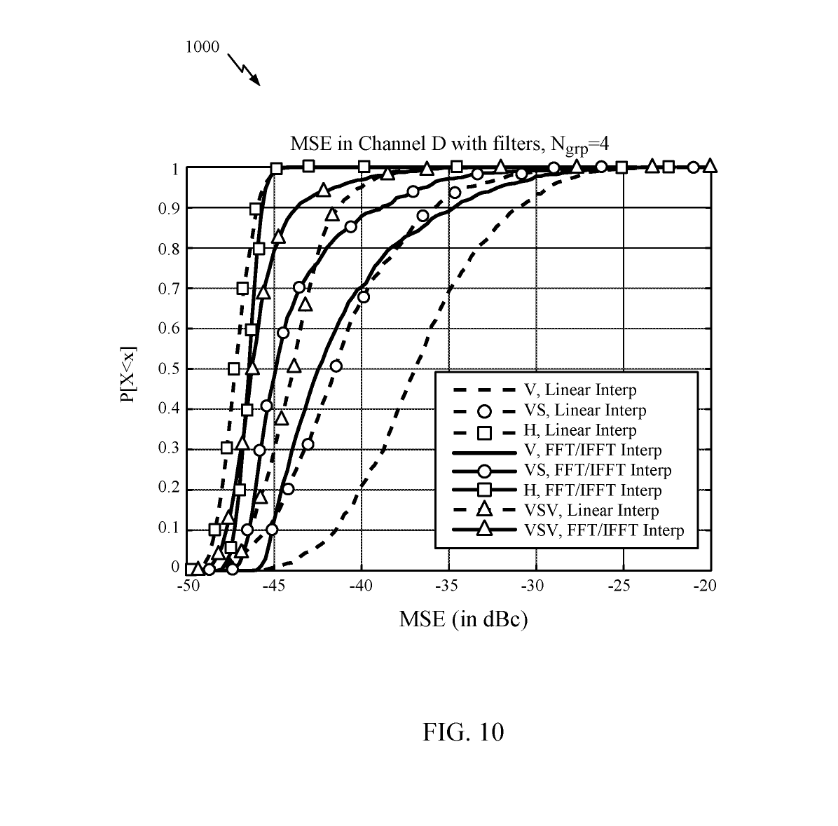

FIG. 10 is a graph 1000 illustrating example performance results based on simulations using sounding procedures, in accordance with aspects of the present disclosure. The simulation results show a probability (on the Y-axis) of achieving the mean square error (MSE) shown in the X-axis. V matrix has been smoothed to remove discontinuities, VSV in legend below stands for VS2V*, tone augmentation as described (around band edges and DC) is used for FFT/IFFT interpolation at AP, and assumes Tx/Rx filters, modeled as 10th-order Butterworth filter to model lengthening of impulse response and the resulting increased frequency selectivity. Solid curves assume edge tones are augmented at N_{g}=1, and other tones are sent at N_{g}=4 (e.g., N_{g}=1 augmentation at edges may only be possible with 4×LTFs). Dashed curves assume N_{g}=4 feedback everywhere and simple linear interpolation, with a lower bound of N_{g}=4 performance for 1×, 2× and 4×LTFs in NDP. Bounds of N_{g}=4 with 1×LTF and 2×LTF in NDP are as follows. With 1×LTFs, edge tones may not be augmented, so linear interpretation may be performed at edges, while more complex (e.g., FFT/IFFT) interpolation may be performed in the middle, with performance expected to be between solid and dashed lines. With 2×LTFs, edge tones may be augmented at N_{g}=2. In this case, linear interpretation may also be performed at the edges, with more complex interpolation in the middle. Again, performance may be expected to be between solid and dashed lines (e.g., better than 1×LTFs, due to possibility of better edge resolution).

The particular format of the sounding frames described herein (e.g., location of tomes for various fields) may depend on a particular tone plan utilized and different tone plans may correspond to different BW sizes and different RU sizes.

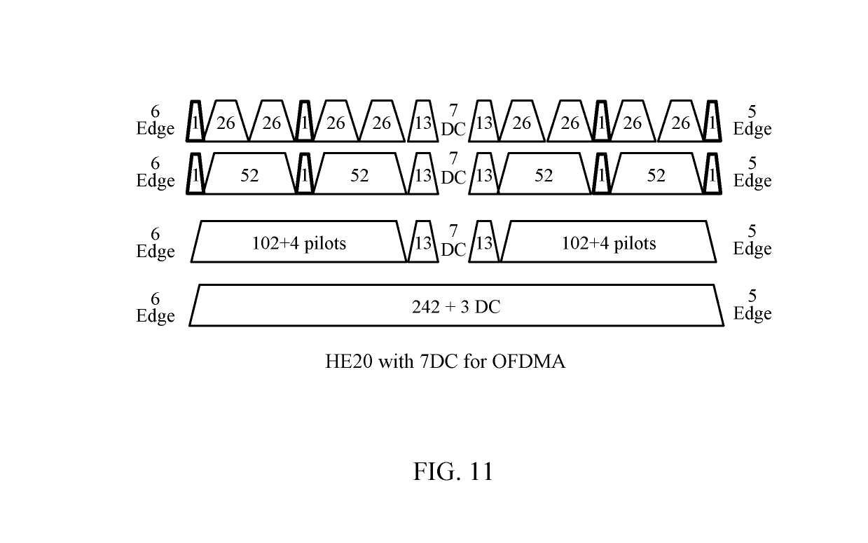

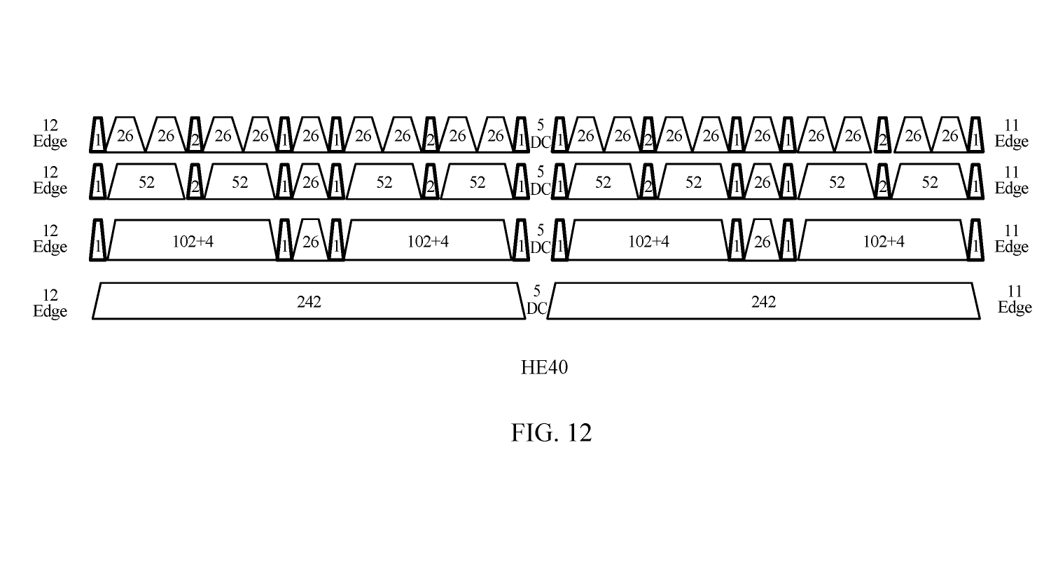

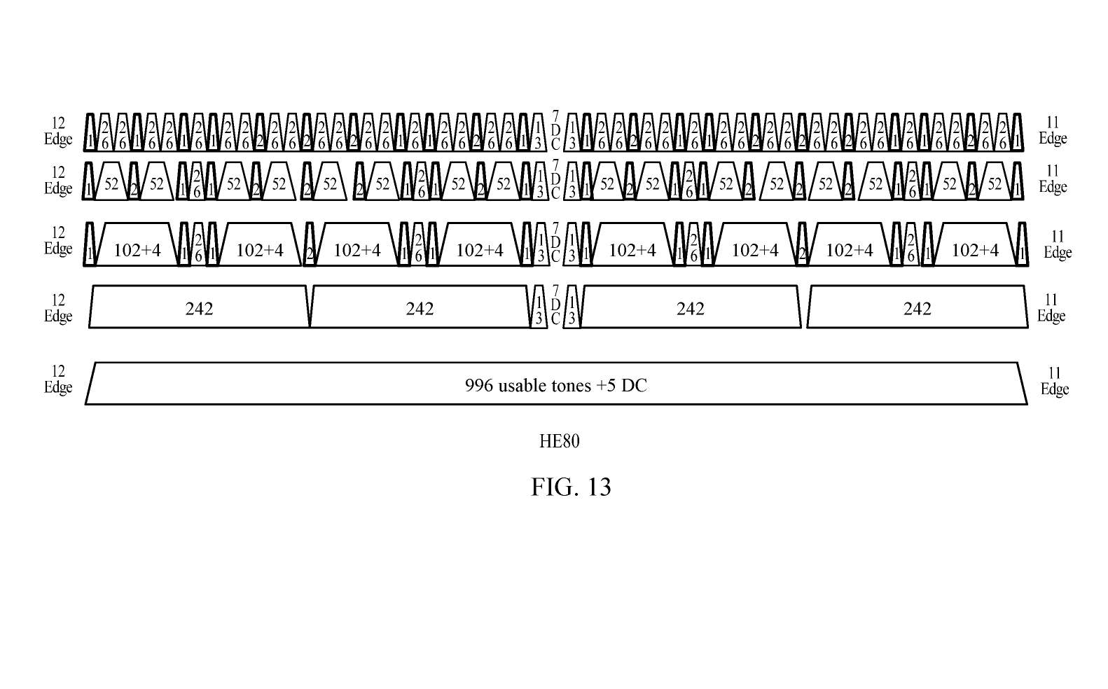

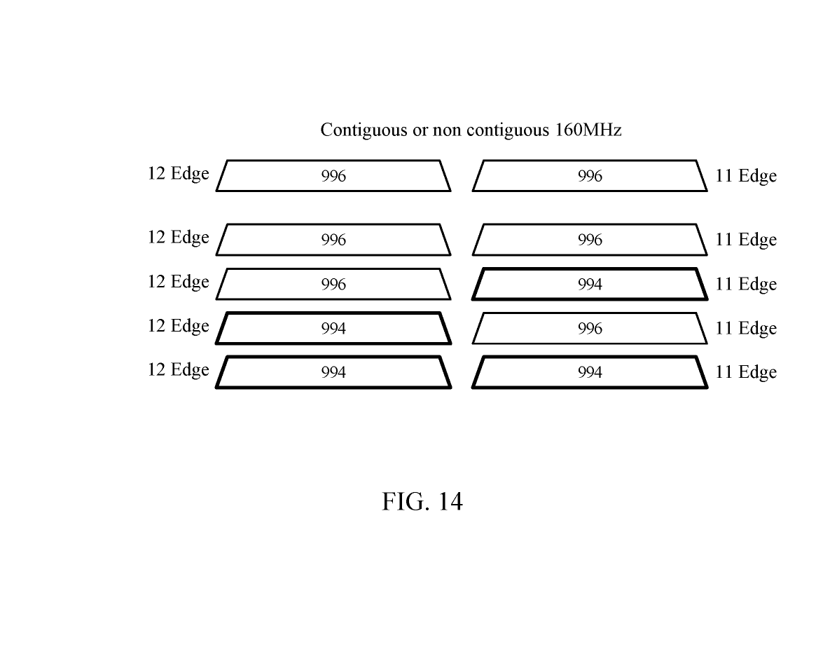

For example, FIGS. 11-14 illustrate example tone plans for 20 MHz, 40 MHz 80 MHz, and 160 MHz OFDMA PPDUs, respectively. As illustrated, exact locations of leftover tones (e.g., with 0 energy) when using 26, 52 or 106-tone RUs within a 242 tone unit are shown. As illustrated in FIGS. 11-14, possible RU locations in a 40 MHz OFDMA PPDU may be roughly equivalent to two replicas of possible RU locations in the 20 MHz OFDMA PPDU. Similarly, possible RU locations in an 80 MHz OFDMA PPDU may be roughly equivalent to two replicas of the possible RU locations in a 40 MHz OFDMA PPDU plus one central 26-tone. As illustrated, the 160 MHz tone plan of FIG. 14 may consist of two 80 MHz tone plans.

### Example Sounding Procedure Enhancements

Using different types of LTFs in beam formed packets may create certain challenges. For example, for beamformed packets with a 4× data portion and 1× or 2× LTFs, there could potentially be a mismatch between the estimated channel (calculated at a receiving station) and a beamforming (BF) matrix calculated at a transmitting access point.

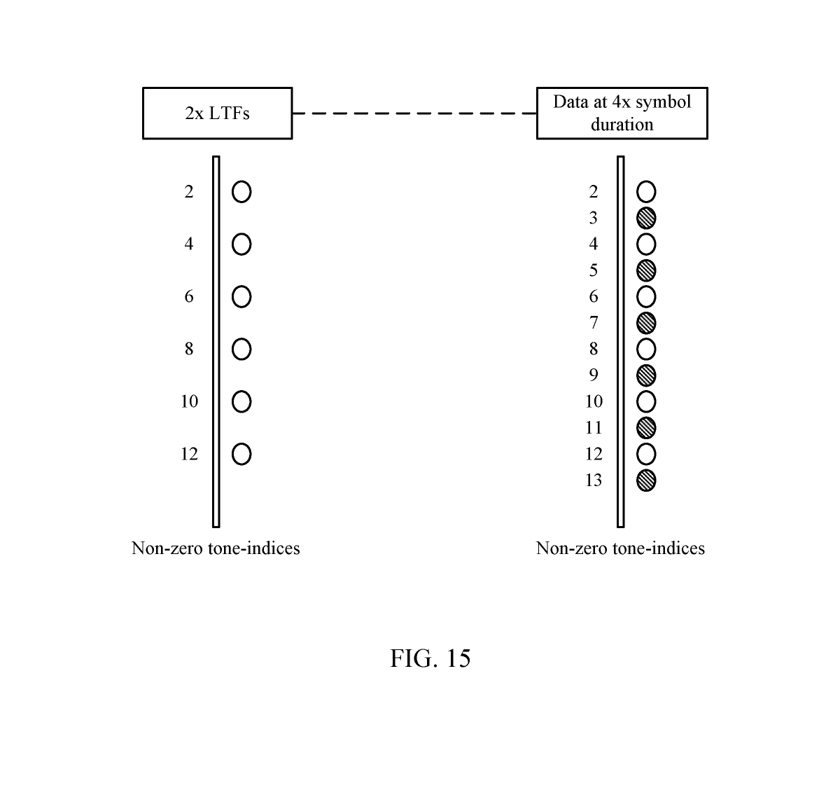

In other words, as illustrated in FIG. 15, in such transmissions the channel estimate may not be available on all the data tones (tones populated in the data portion) as the LTFs can be 1× or 2× (populating only every 4 or every other tone relative to the data portion). In FIG. 15, hashed tones in the 4× data portion correspond to tones (every other tone) that are not populated in the 2×LTF. For those tones, the station may have to perform interpolation to estimate the channel for the beamformed transmission. Similarly, if the station provided feedback based on tone grouping (e.g., N_{g}≧2), then the AP may have to perform some type of interpolation to calculate precoder values (for the beamforming matrix) for those same tones.

Aspects of the present disclosure provide a mechanism that may help ensure continuity between the interpolation applied at the AP (for precoding the beamformed data portion for those tones) and interpolation applied at the station (to estimate the channel for those tones). In some cases, one or more rules may be applied at both the AP and station to ensure such continuity. For example, one rule may be that the precoder on the orange tones is calculated based on an average of the (precoder for the) two neighboring blue tones. The station may then apply this same interpolation when calculating a channel estimate for those same tones based on the 2×LTF (and then use the channel estimate to process the 4× data portion).

According to certain aspects, an access point (e.g., AP 110) may perform interpolation for beamforming. For example, the AP may generate a beamforming matrix having precoding for tones of the data portion not occupied by the one or more training fields calculated based on interpolation of tones occupied by the one or more training fields. The AP transmits the one or more frames, having training fields, using the beamforming matrix. Thus, the station (e.g., station 120) can perform interpolation for channel estimation. For example, the station may calculate a channel estimate based on the one or more training fields. The channel estimate for tones of the data portion not occupied by the one or more training fields may be calculated based on interpolation of tones occupied by the one or more training fields. The interpolation may be based on a type of interpolation used when calculating a beamforming matrix to transmit the data portion. The station may then processes the data portion based on the channel estimate.

As noted above, in some cases a sounding protocol may involve sending sounding frames that are specific to one type of device. For example, this approach may be a default mode of operation when sounding a group where all the STAs are 11ax capable. In this case, not combining the trigger frame with other frames, although may not provide backward compatibility, may have a benefit of preserving the similarity with regular uplink multi-user (UL MU) protocols.

On the other hand, a sounding protocol that is backward compatible (e.g., with at least a portion decodable by different types of stations) may have a benefit of improved efficiency for sounding feedback of 11ax STAs and saving the duplication of NDPA and NDP frames. This may also be beneficial to accommodate the likely scenario of a system having a mix of different types of stations (e.g., a mix of 11ac and 11ax STAs). While backwards compatibility with an announcement (e.g., NDPA) and trigger frame (e.g., NDP) may be possible, it may be a challenge for different types of LTFs (e.g., 1×LTF in VHT-NDP) to adequately support 4× beamformed data (due to extrapolation issues). In some cases, a VHT-NDP frame may be modified to add more edge tones in the LTF without impacting legacy devices.

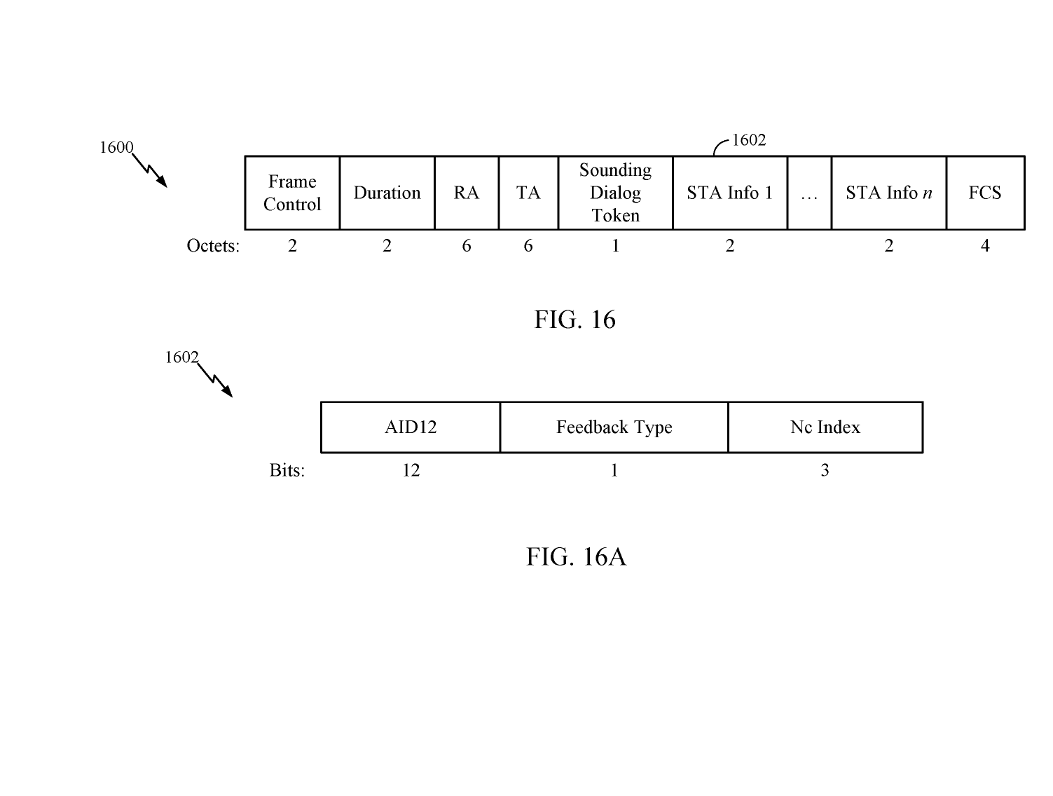

FIG. 16 illustrates an example announcement (NDPA) frame 1600 and FIG. 16A illustrates a corresponding station information field 1602 of the NDPA frame 1600. As illustrated, the NDPA frame 1600 may include STA information field(s) 1602 with feedback information (e.g., Feedback type and N_{c} Index) for stations identified by an association ID (AID).

In some cases, the content of an NDPA frame may be modified (e.g., to include additional information) for 11ax capable devices. In such cases, backward compatibility may still be achieved by sending such a modified NDPA frame with a “legacy” physical (PHY) header (e.g., decodable by legacy devices) or it could be sent using an 11ax PHY header.

There may be various reasons to modify the content of an NDPA frame for 11ax devices. For example, such modification may allow for an expanded amount of information to be provided in STA information fields, such as different types of feedback (e.g., CQI only feedback or partial band feedback). As an example, the STA info field may be expanded to carry the following info: subcarrier group length Ng, a RU/sub-band index, a parameter indicating a Type (s) of information being requested (e.g., CSI feedback, CQI feedback, Best or top few sub-band/RU, Heavily interfered or worst few sub-bands and RUs). As mentioned above, in some cases, trigger information could also be included in an NDP-A. In some cases, the NDPA may carry additional information about the NDP, such as an NDP-type indication (e.g., VHT NDP vs HE-NDP or an LTF symbol duration used in the HE-NDP).

According to certain aspects, the AP (e.g., AP 110) may send an announcement frame that includes additional station information, but that is still backward compatible, in accordance with aspects of the present disclosure. For example, the AP may generate a first type of announcement frame indicating an order in which the indicated stations are to respond with channel information. The indicated stations may include both legacy and non-legacy STAs. Thus, the announcement frame may include a preamble decodable by both the first and second types of station, a first type feedback information field decodable by both the first and second types stations, and second type feedback information fields decodable by the non-legacy stations, but not decodable by the legacy stations. The stations may decode at least the second type feedback information fields to determine information about feedback to be generated and provided to the AP.

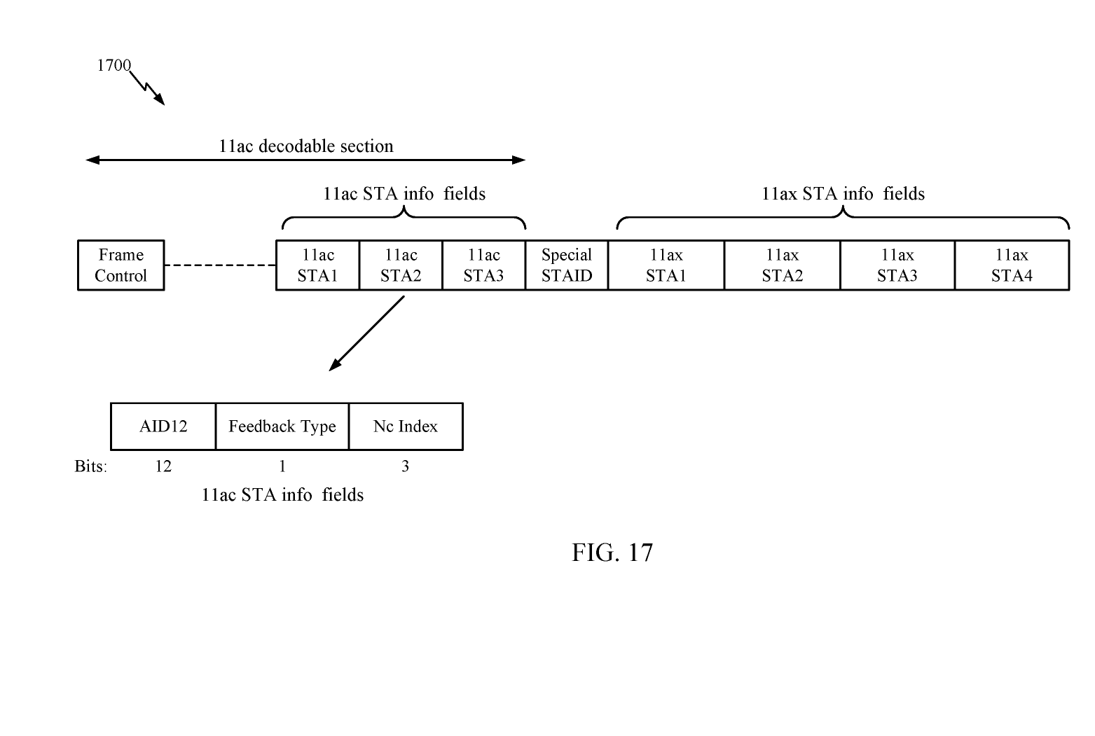

FIG. 17 illustrates an example of an NDPA frame 1700 that may include extended station information fields (e.g., for 11ax capable devices) and still be backward compatible (e.g., decodable by 11ac capable devices). As illustrated in FIG. 17, the NDPA frame 1700 may have a section (e.g., including a PHY header and a first set of station information fields) decodable by 11ac capable STAs. In some cases, the frame may include an indication of when the 11ac portion is ending and the (extended) STA info of 11ax capable STAs (e.g., with different size of STA info field) is starting. As illustrated in FIG. 17, this may be achieved by including a special AID acting as a delimiter between the 11ac portions and the 11ax portions (which may be longer than the 11ac portions due to additional/extended information described above).

As described herein, options exist for providing modified content (in STA information fields) and such frames may be transmitted with legacy (11ac) PHY portions or 11ax PHY portions. Sending an NDPA frame using 11ax PHY may be beneficial, for example, to make sure the NDPA frame allows for sounding outdoor STAs (due to longer CP in 11ax PHY). On the other hand, sending an NDPA frame using an 11ac PHY may achieve sounding of both 11ac and 11ax devices using the same procedure.

As described above, one option is to send an NDPA frame with unmodified (e.g., as in 11ac) content of the NDPA frame. Thus, the trigger frame for sounding may carry the additional information about feedback type with. The lack of extended information may not allow (11ax) devices to know about the type and/or details of feedback being requested until the trigger frame arrives.

There may also be various 11ax formats to use for sending a modified NDPA (e.g., a HE-NDPA) frame. For example, the PHY portion may include a multi-user (MU) format within a SIG-B field. As an alternative, the PHY portion may include an SU format without an HE-SIGB, which may result in a smaller preamble.

In summary, one option for sending NDPA information is to use the same NDPA frame content as VHT and sending such an NDPA frame with an 11ac PHY portion. While this option may provide backwards compatibility, it may not be able to convey new types of feedback in the NDPA frame. Thus, a trigger frame may carry this information and, due to the shorter CP length relative to 11ax PHY, such an NDPA frame may not be ideal for outdoor channels. A second option is for NDPA frame content modified for 11ax devices, with the NDPA frame sent using 11ac PHY. This option may be used for indoor environments and may allow for sounding of 11ax and 11ac devices together without a new trigger frame.

A third option is to send an NDPA frame with content modified for 11ax devices, but using an 11ax PHY portion. This option may be suitable for outdoor devices and may also allow the conveyance of new feedback types for 11ax, albeit at the cost of a loss of backwards compatibility and a slightly longer preamble. In some cases, this third option may be used as a default mode, while sounding to a group of 11ax STAs. If 11ac stations are detected, one of the other options may be used to allow for sounding the 11ax and 11ac capable STAs together in a backward compatible way.

In some cases, a modified NDP frame (e.g., a HE-NDP) may be used, for example, for outdoor STAs. The use of a VHT-NDP (or a backward compatible HE-NDP) may be used to enable the sounding protocol described above with reference to FIG. 8. An HE-NDP may be suitable for an outdoor use-case.

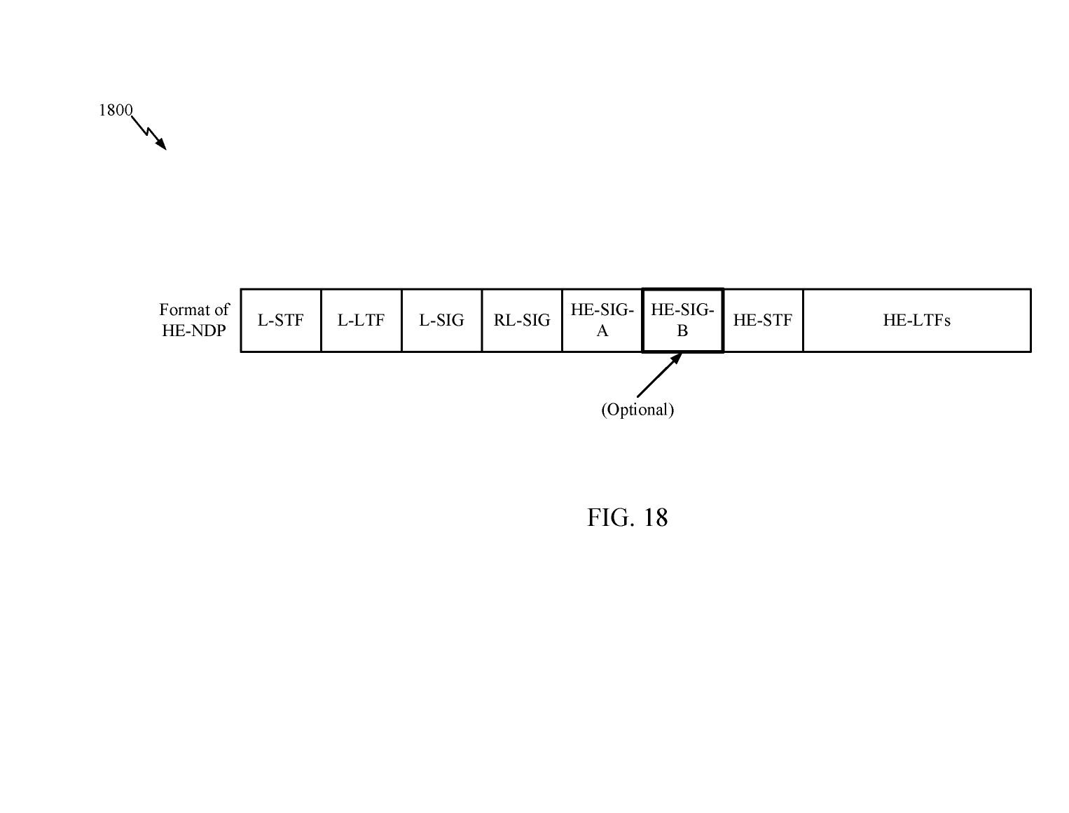

FIG. 18 illustrates an example HE-NDP frame 1800. The example HE-NDP frame 1800 may allow multiple HE-LTF durations. In some cases, a 1×LTF may be used, but 2×LTFs may be more suitable for outdoor channels. As illustrated in FIG. 18, an HE-SIG-B could be used, but is optional. In some cases, an SU frame format may be used for the HE-NDP. If a SIG-B is not included, this NDP may be very similar in size to a VHT-NDP frame format. In some cases, the combination of length field in L-SIG and Nsts in SIG-A may be used to identify that this is an NDP frame (designed to trigger sounding). In some cases, the LTF duration of NDP may be specified in an HE-SIG-A field. In some cases, a bit may be re-interpreted to differentiate between 2× and 4×LTFs in data packets to signify the choice between 1× and 2×LTFs.

As noted above, in some cases there may be extrapolation issues when using LTFs of different sizes in an NDP. For example, for an 11ac 20 MHz, the LTF populates tones from −28 to −1 and from 1 to 28 in steps of 1 tone. In the 4× domain, this translates to tones from −112 to −4 and from 4 to 112 in steps of 4 tones, while data transmissions happen on all tones from −122 to −2 and 2 to 122. This scenario may imply a benefit could be gained by using extrapolation (e.g., on 10 tones on the left edge and 10 tones on the right edge). Some possible ways to address this may be to add more edge tones in 1×LTF (e.g., instead of 56 tones in 20 MHz, transmit 58 or 60 tones). Techniques to address this, however, may take into account the impact on mask compliance, adjacent channel interference (ACI) targets, and the like. In some cases, 1×LTFs in NDP might not work for 11ax beamforming. How to address these issues may depend on the impact of extrapolation loss with VHT-NDP and whether additional tones can be added on the edge without impacting emissions.

In some cases, it may be possible to multiplex data within NDPA frames. For example, if an MU format is used, data may be multiplexed in the announcement frames using OFDMA.

### Example Sounding Protocol for HE SU Feedback

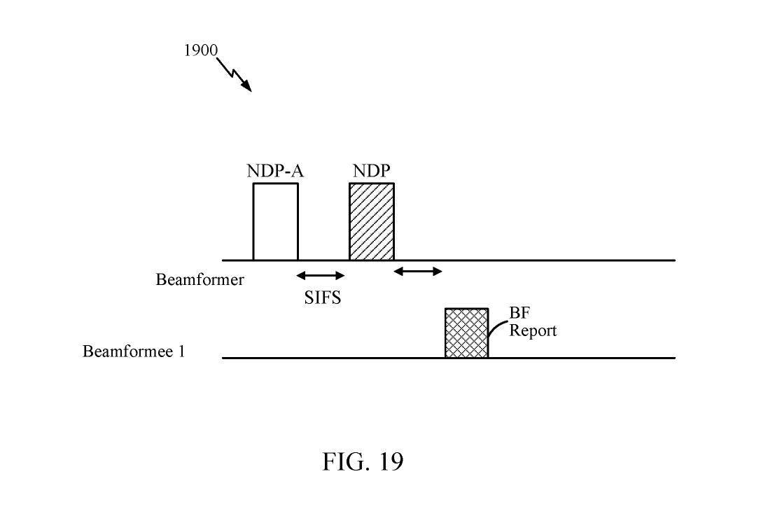

According to certain aspects, for HE SU feedback, a sounding protocol 1900 similar to VHT sounding protocol may be used, as shown in FIG. 19. In this case, a trigger frame may not be sent. If feedback is only requested for one STA, no trigger frame may be needed.

In one example implementation, 1 bit in the feedback parameter control field in the NDPA or NDP may be used to indicate whether or not there will be a trigger frame before the beamforming report feedback. Alternatively, the STA may assume the first STA's report always follows the NDP without a trigger or polling frame. In the sounding protocol 1900, where a trigger frame is used before any beamforming report, the first STA info field may be set by using an empty STA AID.

### Example Control of Feedback Parameters

As discussed above, the AP can request/indicate parameters to be used for the channel information feedback. For example, the parameters, such as the subsampling factor N_{g} and the number of streams, N_{c}, may be included in the NDPA frame format (e.g., FIGS. 16-16A shows an example NDPA that can be modified to include feedback information). The Feedback Type field can indicate MU feedback (e.g., 1) or SU feedback (e.g., 0). The N_{c} Index field may be reserved in SU; for MU, it can be a value 0-7 to indicate 1-8 spatial streams. For SU, feedback can include per-stream SNR and a V matrix with feedback per tone; for MU, feedback can include per-stream SNR and a V matrix and delta SNR with feedback per tone and per-stream.

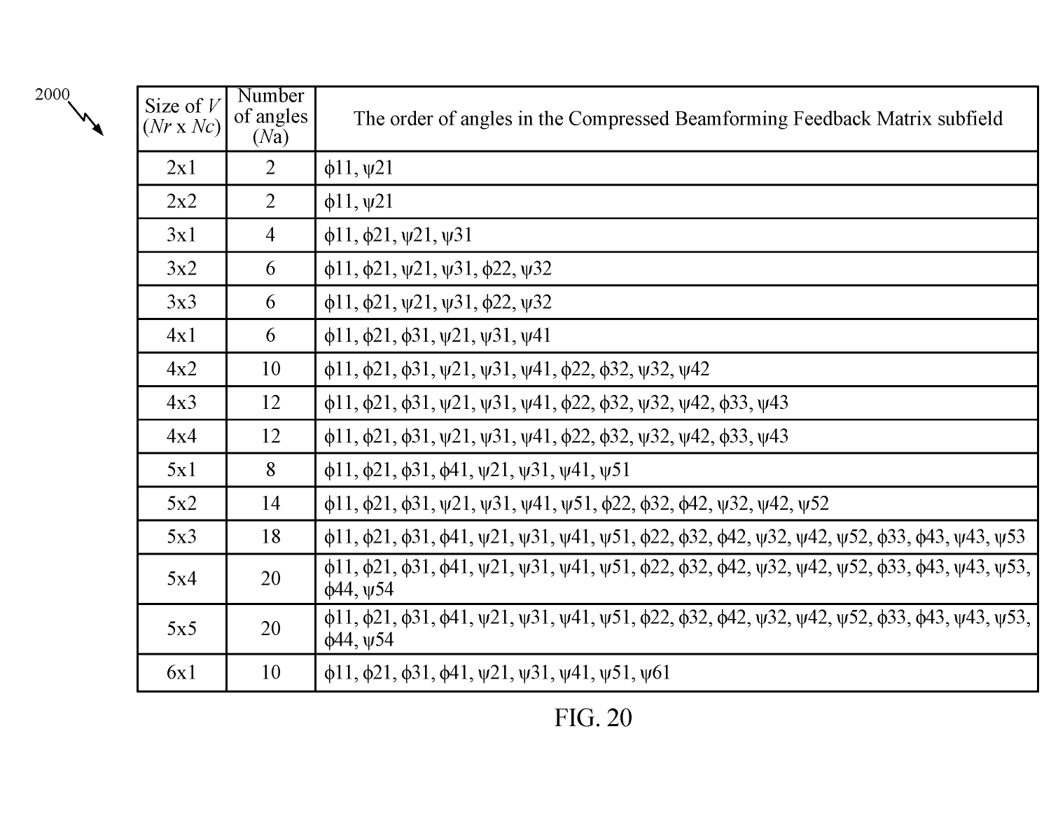

The size of the V matrix can be Nr×Nc. The number of angles can be Na. FIG. 20 is a table showing an example order of angles in the Compressed Beamforming Feedback Matrix subfield 2000 for various V matrices, in accordance with certain aspects of the present disclosure. However, these example are non-limiting and there may be other examples not shown in FIG. 20. In the description in this document, the V matrix feedback refers to certain compressed version of the V matrix. One example, as in 11ac, is to use the angles described in FIG. 20.

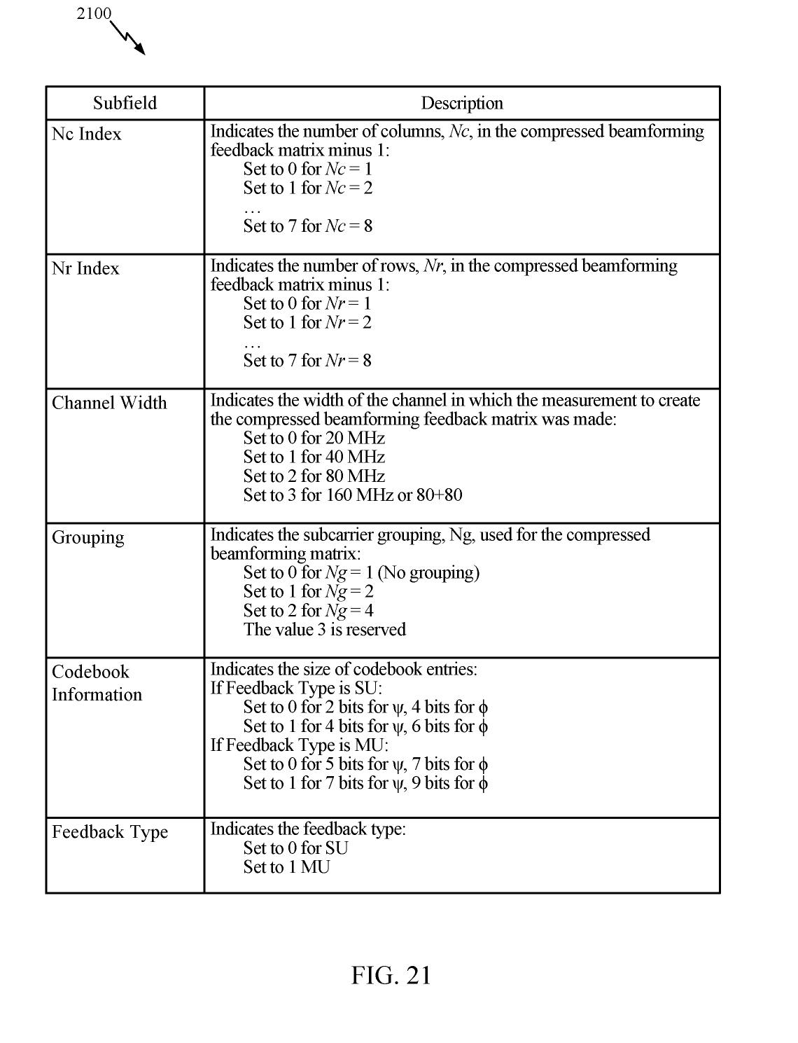

FIG. 21 is a table showing example subfield descriptions for a VHT MIMO Control field 2100, in accordance with certain aspects of the present disclosure. Although not shown in FIG. 21, other subfields may also be included in the VHT MIMO Control field. The VHT MIMO Control field can be sent in every VHT compressed beamforming frame, before the beamforming report. As shown in FIG. 25, the subfields can include N_{c}, Nᵣ, channel width, N_{g}, codebook information, feedback type, Remaining Feedback Segments, First Feedback Segment, and Sounding Dialog Token Number. N_{c} index field indicates the number of columns N_{c} in the compressed beamforming feedback matrix (V) minus one; Nᵣ index field indicates the number of rows Nᵣ in the compressed beamforming feedback matrix (V) minus one; channel width indicates the width of the channel in which the measurement to create the compressed beamforming feedback matrix (V) was made; N_{g} indicates the subcarrier grouping used for the compressed beamforming feedback matrix (V); codebook information indicates the size of codebook entries (quantization); and feedback type indicates the MU or SU.

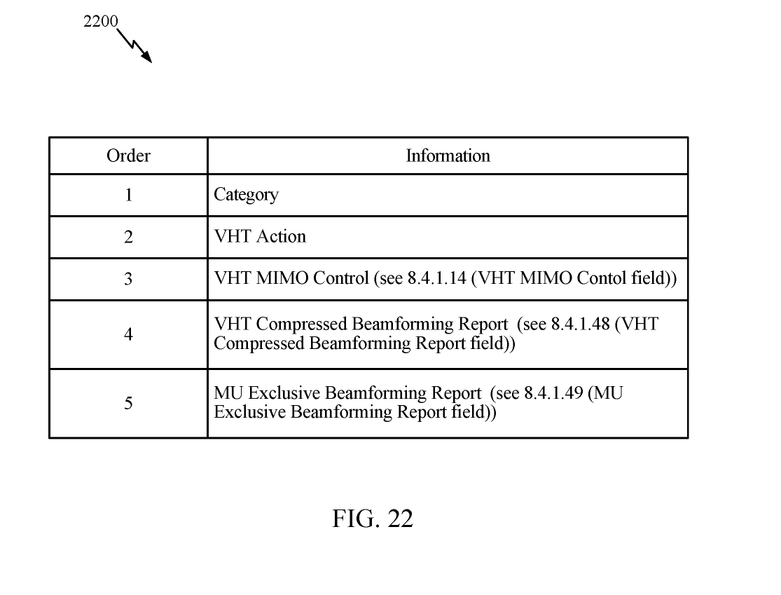

FIG. 22 is table showing an example VHT Compressed Beamforming frame Action field format 2220, in accordance with certain aspects of the present disclosure. As shown in FIG. 22, the VHT Compressed Beamforming frame Action field format 2200 includes the VHT MIMO Control field (e.g., as described above with respect to FIG. 25), the VHT Compressed Beamforming Report (e.g., with per-stream SNR and V matrix per feedback tone), and MU Exclusive Beamforming Report (e.g., with per-stream delta SNR per feedback tone for MU).

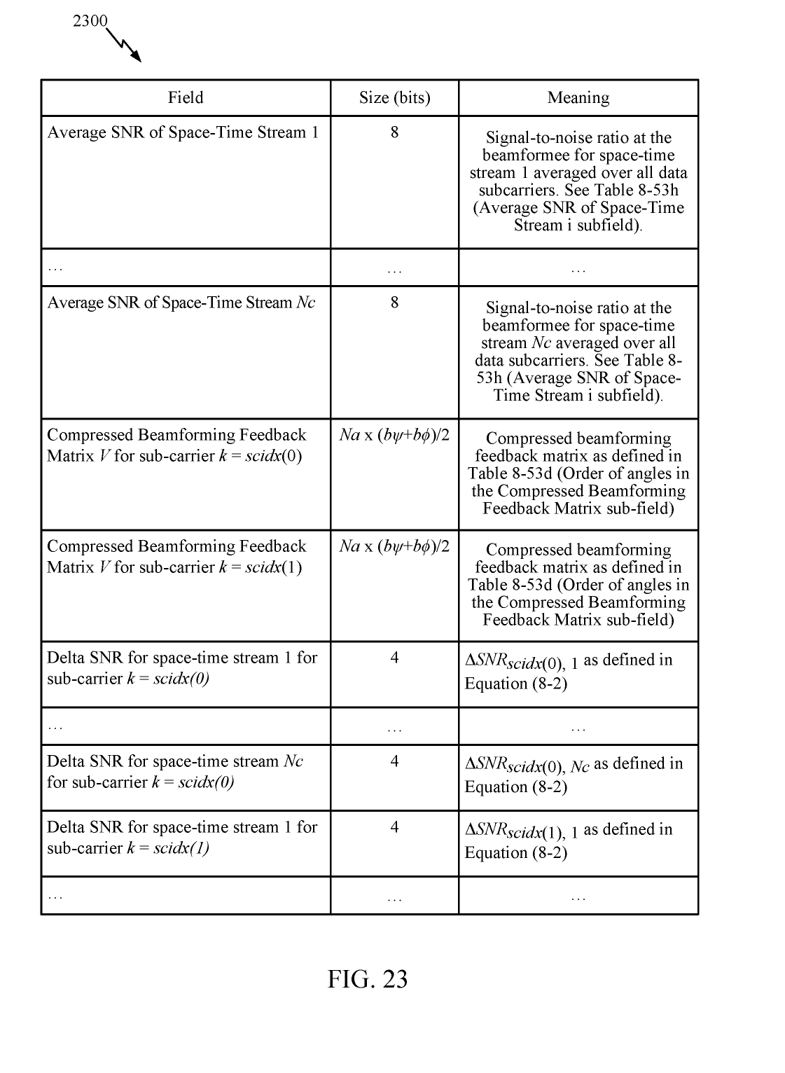

FIG. 23 is a table showing an example Beamforming Report structure 2300, in accordance with certain aspects of the present disclosure. As shown in FIG. 23, an Average SNR field can be included for each space-time stream being reported (e.g., in order from SS1 to SS N_{c}). A Compressed Beamforming Feedback Matrix V field can be included for each subcarrier (tone) being reported (e.g., in order). For MU feedback, a Delta SNR can be included for each subcarrier (tone) being reported (e.g., in order) in the MU Exclusive Beamforming report.

According to certain aspects, in certain systems (e.g., 802.11ax systems) it may be desirable for the AP to control feedback parameters. For example, the AP may schedule the transmission of sounding feedback in UL MU packets, so it may be desirable for the AP to know the size of the packets. Thus, the AP may determine the feedback parameters N_{g}, N_{c}, and quantization for the SU and MU types of feedback.

As shown in FIG. 7, in sounding protocol 700, the AP send the NDPA, the NDP, and then the trigger frame, after which the STA may send feedback. Since feedback computation by the STAs is dependent on the feedback parameters N_{g}, N_{c}, and quantization, it may be desirable for the STAs to get information about the parameters early. Therefore, according to certain aspects, N_{g} and N_{c} for MU, and quantization information may be included in the NDPA.

### Example Control of N_{c}

As mentioned above, N_{c} is the number of columns in V matrix feedback. Control of N_{c} may be handled according to various options. In certain systems (e.g., 802.11ac systems), N_{c} is controlled by the beamformee for SU type feedback and by the AP for MU type feedback. N_{c} for MU type feedback may be capped by the maximum number of supported spatial stream Nₛₛ according to the beamformee's Rx VHT-MCS Map subfield in the Supported VHT-MCS and Nₛₛ Set field and/or the Max Nₛₛ indicated in the most recent Operating Mode Field. In certain other systems (e.g., 802.11ax), control of N_{c} may not be handled separately for SU and MU type feedback; instead, SU and MU type feedback may combined into one feedback type.

In one example, for MU feedback, the beamformer may not request N_{c}>max (4, number of spatial streams supported by the beamformee) because the number of spatial streams per user in DL MU-MIMO is less than or equal to four and for SU, the beamformee can choose N_{c}. In this case, the feedback report may be in UL SU, instead of UL MU frames.

In another example, N_{c},max for SU feedback may be chosen by the beamformer and the beamformee may be allowed to generate CBF with N_{c}≦N_{c},max. For MU feedback, the beamformer may not request N_{c}>4. N_{c},max may be sent in the HE NDPA. Padding may be used to make up the feedback size according to N_{c},max.

In yet another example, the beamformer may choose N_{c} or N_{c},max for both SU and MU feedback. In this case, there may be a negotiation such that the beamformee can indicate the max N_{c} that it can generate. N_{c},max may be sent in the HE NDPA.

According to certain aspects, the STA may not be configured with separate feedback types for MU and SU; instead, the STA may be configured with only one type feedback. In one example, SU and MU feedback types can be combined into one feedback type.

If the access point (AP) controls N_{c}, along with N_{g} and quantization, the AP may be able to pre-compute the size of the feedback for each user. The AP control may also enable efficient allocation of resources for uplink MU transmissions carrying the feedback.

According to certain aspects, the AP may specify, in the NDPA frame, an N_{c} value for each STA. In this case, each STA may process channel estimates and feedback according to the specified N_{c} value for that STA (e.g., so long as the N_{c} value does not exceed the STA's capability). According to certain aspects, the N_{c} value may be specified somewhere other than in the trigger frame.

In a first option, for MU type feedback, each STA may perform beamforming reporting according to the specified N_{c} value. For SU type feedback, each STA performs beamforming reporting according to an N_{c} value not exceeding the specified N_{c} value and using padding to generate a feedback packet of same length in the case of using this N_{c} value. Alternatively, in a second option, the STA may not support both SU and MU type feedback. Each STA may perform beamforming reporting according to the specified N_{c} value if it does not exceed the STAs capability. If the N_{c} value does exceed the STA's capability, the STA may not perform beamforming reporting according to the its N_{c} value and may use padding to generate a feedback packet of the same length as in the case of using the specified N_{c} value.

In a third option, when polling a set of STAs for a beamforming report, the trigger may further specify a refined N_{c} value for each STA. In this case, for MU type feedback, each STA may perform beamforming reporting according to the refined N_{c} value. For SU type feedback, each STA may perform beamforming reporting according to an N_{c} value not exceeding the refined N_{c} value and use padding to generate a feedback packet of the same length as in the case of using the refined N_{c} value. Alternatively, in a fourth option, the STA may not support both SU and MU type feedback. Each STA may perform beamforming reporting according to the refined N_{c} value if it does not exceed the STAs capability. If the refined N_{c} value does exceed the STA's capability, the STA may not perform beamforming reporting according to the its N_{c} value and may use padding to generate a feedback packet of the same length as in the case of using the refined N_{c} value.

### Example HE NDPA Frame Formats

According to certain aspects, in addition to the parameters included in the VHT NDPA frame format 1600 (e.g., as shown in FIG. 16), additional parameters may be included in a high efficiency (HE) NDPA frame format. For example, N_{g} and quantization may be included in the HE NDPA. N_{g} may be dependent on channel frequency selectivity and one value may be used for all STAs. Alternatively, a different value may be used for each STA (e.g., for load balancing). For quantization, one value may be used for all STAs. Alternatively, a different value may be used for each STA. Thus, there may be four options: one N_{g} value for all STAs and one quantization value for all STAs (Option 1); one N_{g} value for all STAs and one quantization value per STA (e.g., defined in each STA info field) (Option 2); one N_{g} value per STA (e.g., defined in each STA info field) and one quantization value for all STAs (Option 3); or one N_{g} value per STA (e.g., defined in each STA info field) and one quantization value per STA (e.g. defined in each STA info field) (Option 4).

The number of bits to convey the grouping factor N_{g} could be 2 or 3 bits. For example, if 2 bits are used: 0 may be reserved; set to 1 for N_{g}=2; set to 2 for N_{g}=4; and set to 3 for N_{g}=8 or another value or reserved. For example, if 3 bits are used: 0 may be reserved; set to 1 for N_{g}=2; set to 2 for N_{g}=4; and set to 3 for N_{g}=8. In aspects, other values may be used for other N_{g} values or reserved.

The number of bits to convey quantization (or codebook information) could be 1 bit as in 11ac. The number of bits to convey feedback type could 1 (to indicate SU or MU types) as in 11ac or 2 (to indicate SU, MU, or SNR only type).

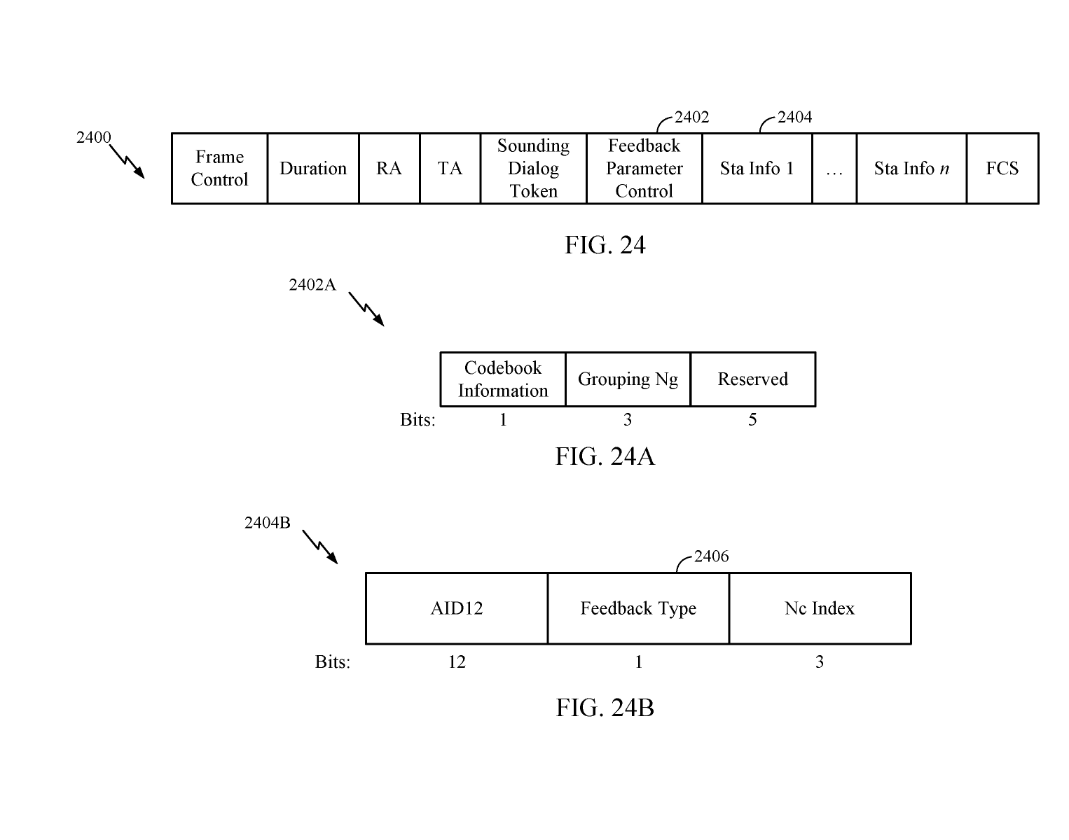

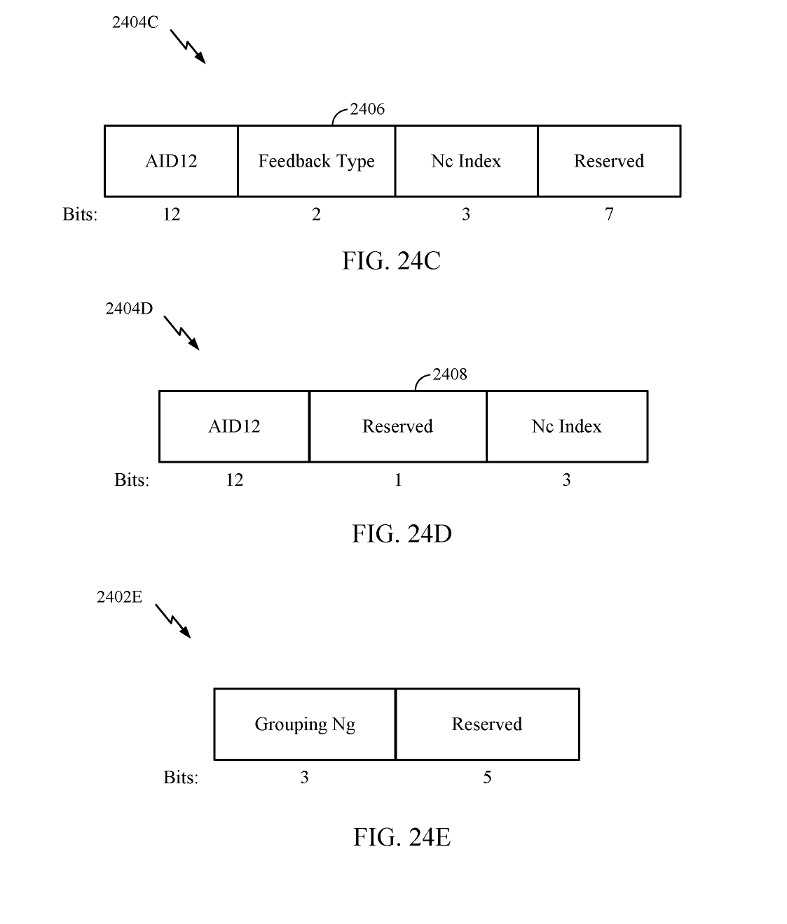

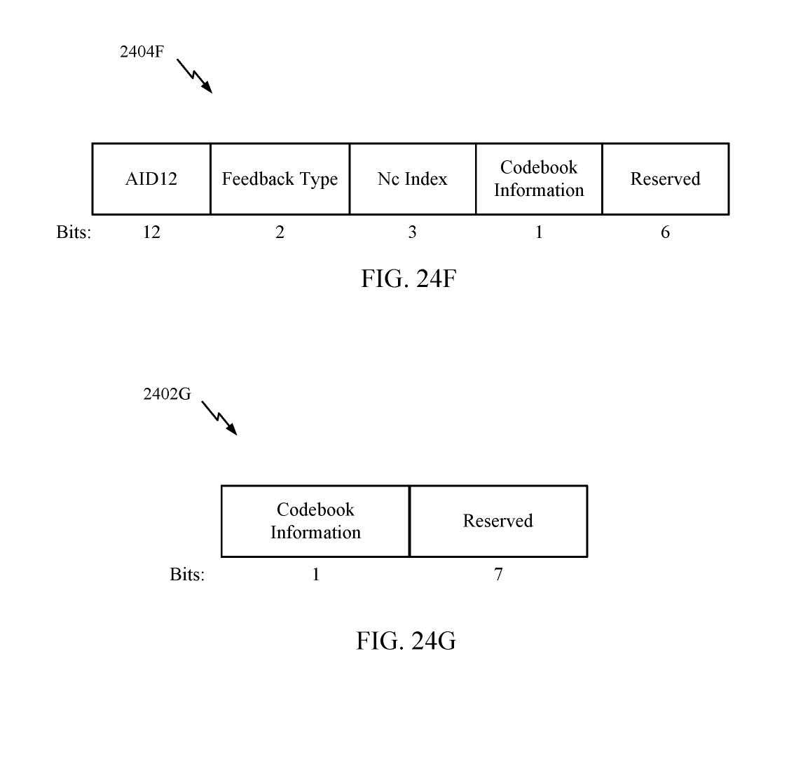

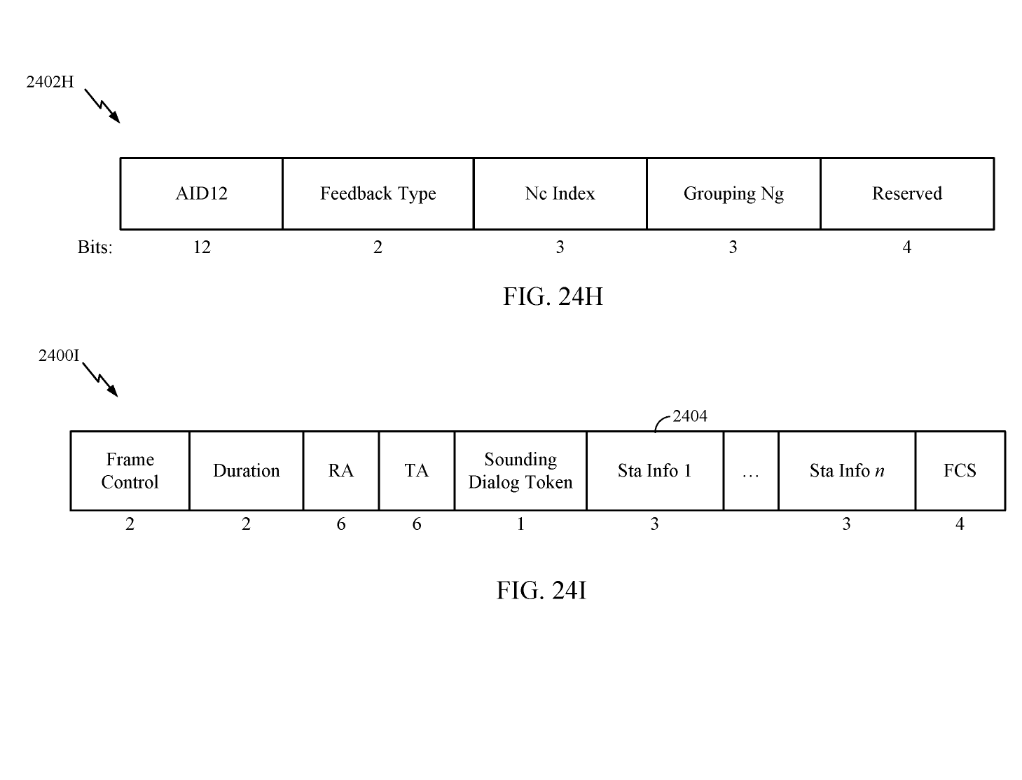

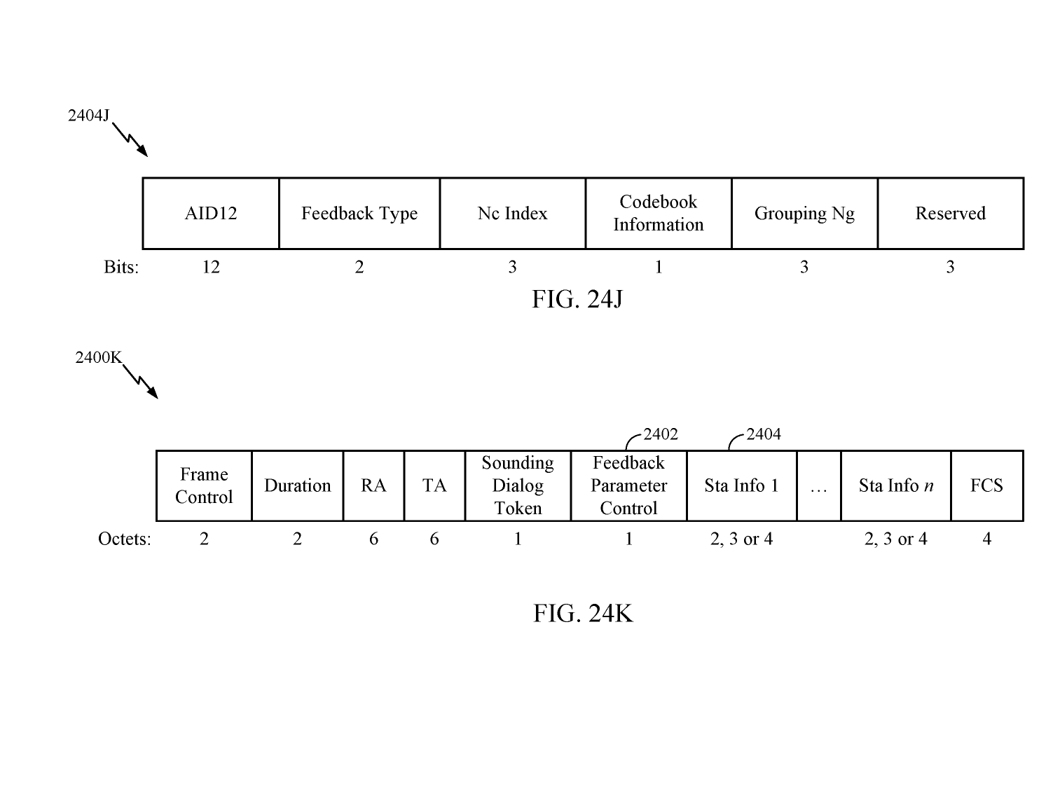

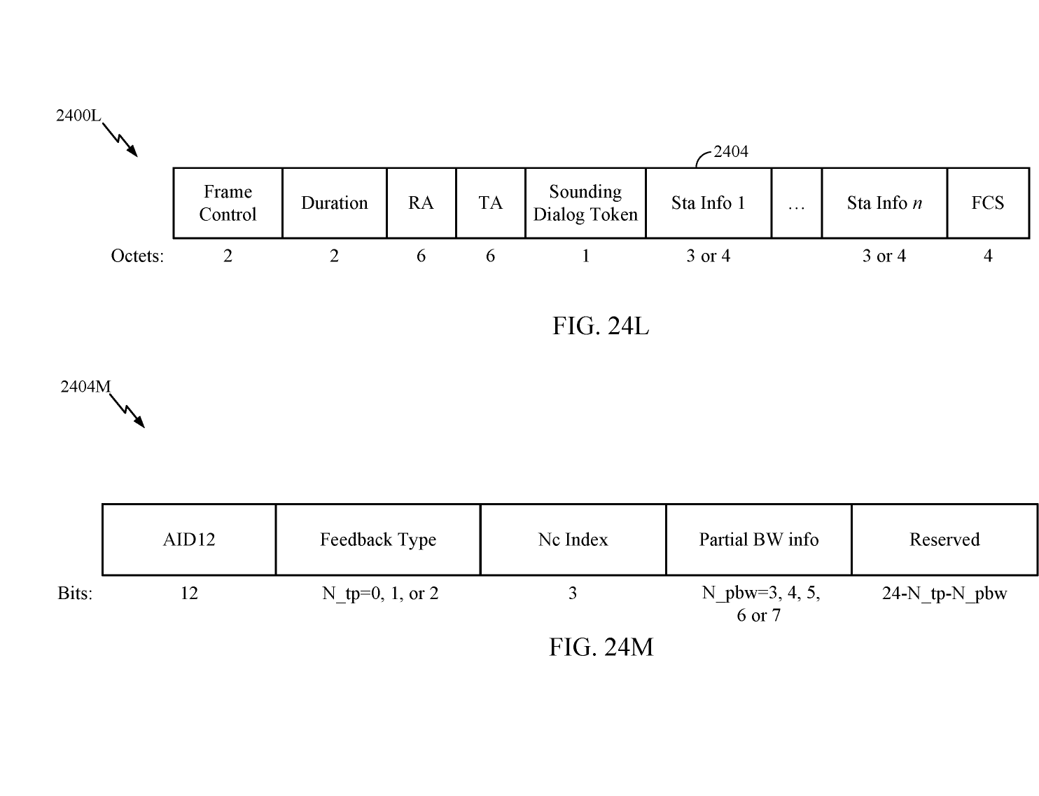

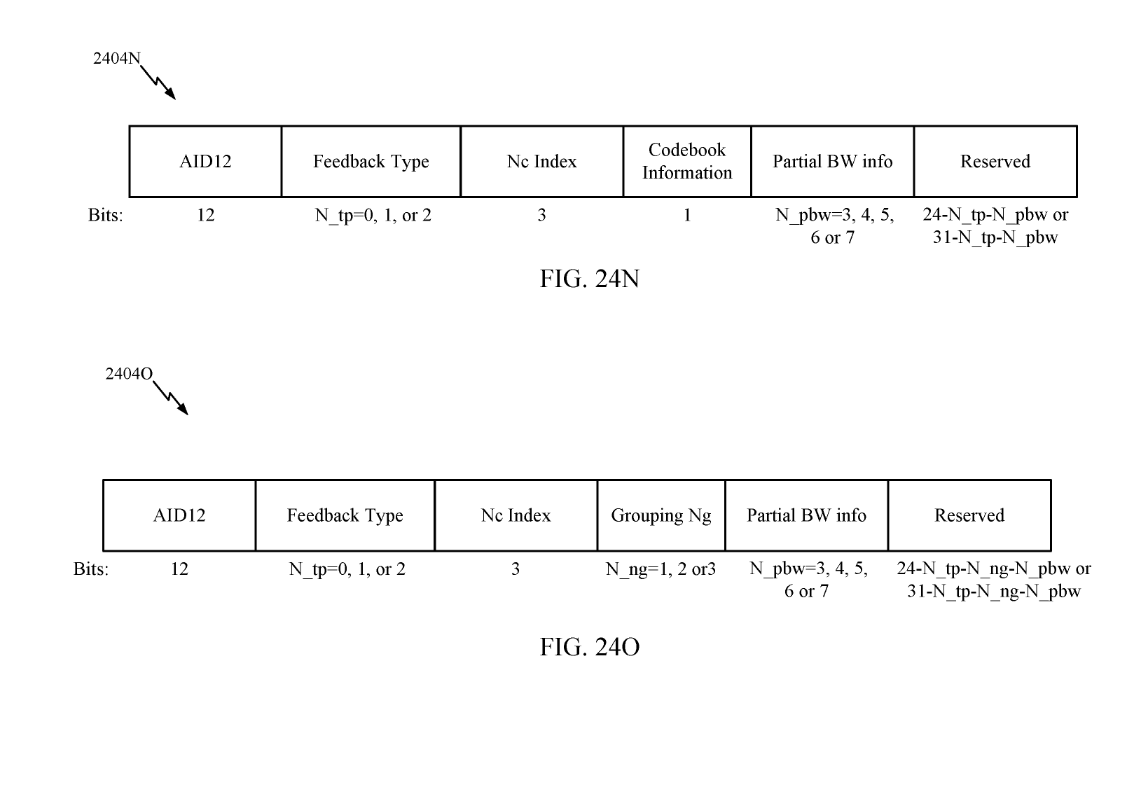

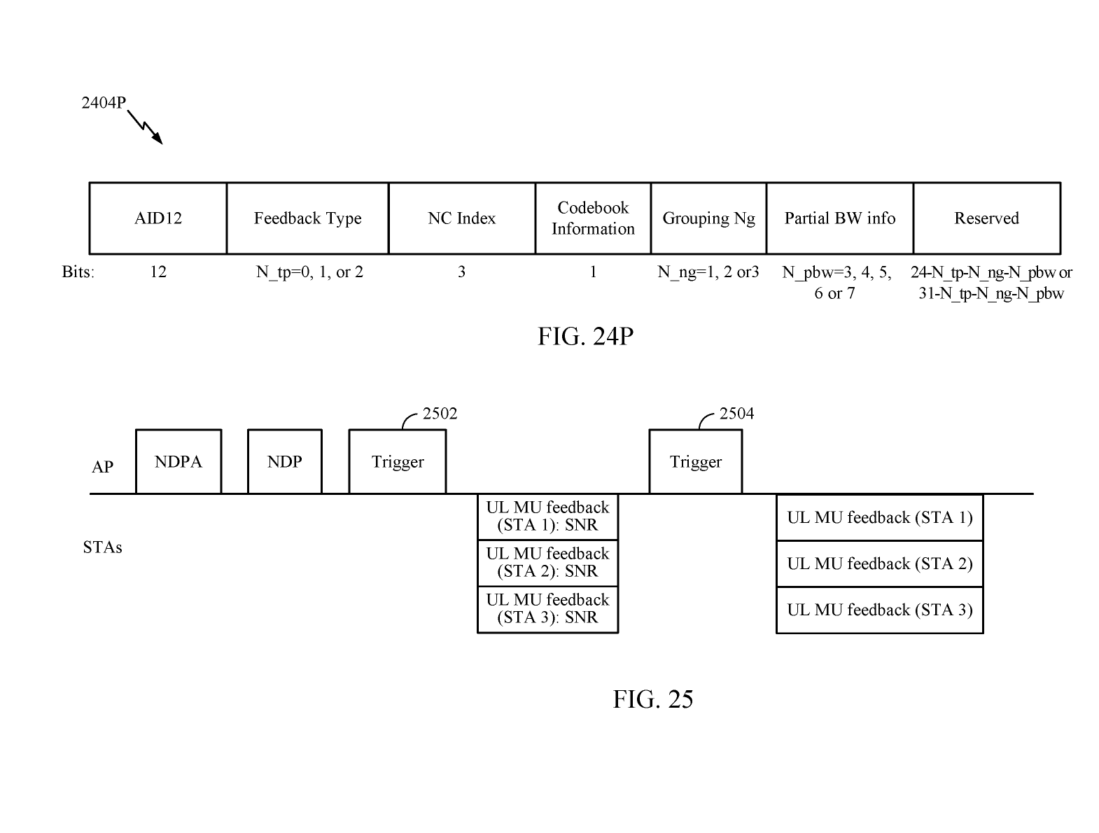

If N_{g} and/or quantization are not STA dependent, a feedback parameters control field (of length of 1 octet) may be included in the HE NDPA as shown in FIG. 24. FIG. 24 is an example HE NDPA frame format 2400, in accordance with certain aspects of the present disclosure. As shown in FIG. 24, the HE NDPA frame format 2400 may include an additional Feedback Parameter Control field. FIG. 24A shows example subfields of a Feedback Parameter Control field 2402 of HE NDPA frame format 2400 shown in FIG. 24, in accordance with certain aspects of the present disclosure. If one N_{g} value for all STAs and one quantization value for all STAs (Option 1), the Feedback Parameter Control field 2402A may include Codebook information, N_{g}, and a Reserved field as shown in FIG. 24A. If the feedback types only include SU or MU (Option 1a), the STA info field(s) 2404 may include the subfields shown in FIG. 24B. If the feedback type include SU, MU, and SNR only (Option 1b), the STA info field(s) 2404C may include the subfields shown in FIG. 24C. If no SU/MU type feedback is supported (option 1c), the feedback type field 2406 may be replaced by a reserved field 2408D as shown in FIG. 24D. In another option, the feedback type field may be omitted.

If one N_{g} value is used for all STAs and one quantization value is used per STA (e.g., defined in each STA info field 2404) (Option 2), the Feedback Parameter Control field 2402E may include Grouping N_{g} and Reserved subfields as shown in FIG. 24E. The STA info field 2404F may include the subfields shown in FIG. 24F.

If one N_{g} value is used per STA (e.g., defined in each STA info field 2404) and one quantization value is used for all STAs (Option 3), the Feedback Parameter Control field 2402G may include Code Information and Reserved subfields as shown in FIG. 24G. The STA info field 2404H may include the subfields shown in FIG. 24H.

If both the N_{g} and quantization feedback parameters are STA dependent (Option 4), the Feedback Parameters Control field 2402 may not be included in the announcement frame 24001 and, instead, additional bits may be used for the STA info field(s) 2404 as shown in FIG. 24I. The STA info field(s) 2404J may include the subfields shown in FIG. 24J.

According to certain aspects, the NDPA frame (e.g., NDPA frame 2400 or 24001) may specify partial bandwidth feedback information. As will be discussed in more detail below, the trigger may also specify the partial bandwidth feedback information. The partial bandwidth feedback information may refine the partial bandwidth feedback information sent earlier in the NDPA frame. The NDPA frame may include a field for the partial bandwidth feedback information for each STA. Alternatively, the partial bandwidth feedback information may be specified only in the trigger frame.

In one example implementation, the NDPA frame may specify a single N_{g} value for all STAs and RUs; a single quantization value for all STAs and RUs; and partial bandwidth feedback information per STA defined in each STA info field (e.g., Option 5). In another example implementation, the NDPA frame may specify a single N_{g} value for all STAs and RUs; a quantization value per STA defined in each STA info field; and partial bandwidth feedback information per STA defined in each STA info field (e.g., Option 6). In another example implementation, the NDPA frame may specify an N_{g} value per STA defined in each STA info field; a single quantization value for all STAs and RUs; and partial bandwidth feedback information per STA defined in each STA info field (e.g., Option 7). In yet another example implementation, the NDPA frame may specify an N_{g} value per STA defined in each STA info field; a quantization value per STA defined in each STA info field; and partial bandwidth feedback information per STA defined in each STA info field (e.g., Option 8).

The HE NDPA frame format 2400, in accordance with the above options 5-7. For example, the number of bits used for the STA Info field(s) 2404 may depend on the particular option. FIG. 24L shows example subfields of an HE NDPA frame format 2400L, in accordance with the above option 8, in which the Feedback Parameter Control field 2402 is excluded.

FIGS. 24M-24O show example subfields 2404M-24040 of STA Info field(s) 2404 of HE NDPA frame format 2400K shown in FIG. 24K for options 5-7, respectively. FIG. 24P shows example subfields 2404P of STA Info field(s) 2404 of HE NDPA frame format 2400L shown in FIG. 24L for option 8. As shown in FIGS. 24M-24P, the Partial BW info field indicates partial BW for which feedback is requested.

According to certain aspects, the number of bits to convey the grouping factor N_{g} could be one, two, or three bits. If one bit is used, the bit may be set to 0 for N_{g}=4 or to 1 for N_{g}=16. If two bits are used, the values 0 and 3 may be reserved and the bit may be set to 1 for N_{g}=4 or to 2 for N_{g}=16. Alternatively, if two bits are used, the values 2 and 3 may be reserved and the bit may be set to 0 for N_{g}=4 or to 1 for N_{g}=16. In another alternative, if two bits are used, the value 0 may be reserved and the bit may be set to 1 for N_{g}=2, 2 for N_{g}=4, or to 3 for N_{g}=16. If three bits are used, the values 0, 1, and 4-7 may be reserved and the bits may be set to 2 for N_{g}=4 or 3 for N_{g}=16. Alternatively, if three bits are used, the values 0, 1, and 5-7 may be reserved and the bits may be set to 2 for N_{g}=4 or 4 for N_{g}=16. In another alternative, if three bits are used, the values 0 and 4-7 may be reserved and the bits may be set to 1 for N_{g}=2, 2 for N_{g}=4, or to 3 for N_{g}=16. In yet another alternative, if three bits are used, the values 0, 3, and 5-7 may be reserved and the bits may be set to 1 for N_{g}=2, 2 for N_{g}=4, or to 4 for N_{g}=16. According to certain aspects, “reserved” values may be used for other N_{g} values (other than 2, 4, 16) or just reserved.

According to certain aspects, the number of bits used to convey the quantization (or codebook information) could be 1 bit. The number of bits for the feedback type could be 0 (e.g., if no SU/MU types are supported), 1 (e.g., if only SU and MU types are supported), or 2 (e.g., if SU type, MU type, and SNR only type feedbacks are supported). For example, the bits may be set to 0 for SU, 1 for MU, or 2 for SNR only.

According to certain aspects, the number of bits for the Partial Bandwidth Feedback information could be from 3 to 7 bits (e.g., depending on the feedback unit design). If the minimum partial bandwidth for feedback is large (e.g., 20 MHz), 3 bits may be enough, for example, using a bit map. In this case, the values 0-7 can indicate 1-8 PHY 20 MHz in a 160/80+80 MHz PPDU bandwidth. If the minimum partial bandwidth for feedback is small (e.g., 2.5 MHz subband or 32 tones), then 6 bits may be used, for example, in a bit map (e.g., since there are 64 such subbands in 160/80+80 MHz). For a 26-tone RU, 7 bits may be used, for example, in a bitmap (e.g., since there are 74 such RUs in 160/80+80 MHz).

### Example Types of Feedback

As mentioned above, feedback types may include SU feedback (e.g., per-stream SNR and V matrix per feedback tone) and MU feedback (e.g., per-stream SNR, V matrix per feedback tone, and per-stream delta SNR per feedback tone) (Option 1a). As also mentioned above, according to certain aspects, an additional feedback may include per-stream SNR only (Option 1b).

According to certain aspects, SU feedback or MU feedback for CSI computation, storage, and/or feedback may be included in the NDPA frame, while basic per-stream SNR feedback, SU feedback, and/or MU feedback may be included in the trigger frame. Feedback may be SU type or MU type. MU type feedback may be used for RU sizes of at least 106 tones, while SU type feedback could be used for smaller RUs. The trigger frame may not indicate a type of feedback that is different from what is included in the NDPA frame; however, the trigger frame can indicate if it requests a basic per-stream SNR only feedback. Thus, if the NDPA frame announces SU type feedback, the trigger may not request MU type feedback. If the NDPA frame announces MU type feedback, but the trigger requests SU type feedback, then feedback may be formatted (e.g., depending on the HE compressed beamforming frame action field design).

In one example, only per-stream SNR feedback and MU type feedback may be used while SU type feedback is not used. This may save 1 bit of indication in both the NDPA frame and the report frame. Feedback of smaller partial bandwidth (e.g., RUs, subbands) could be used to form feedback of larger partial bandwidth (e.g., RUs, subbands). The AP may have flexibility to schedule OFDMA and/or MU-MIMO.

Alternatively, feedback for the three types of feedback (SU type feedback, MU type feedback, and per-stream SNR only feedback) may be used. SU type feedback only may be requested for small RUs used for OFDMA. If an RU may be used for OFDMA MU-MIMO, then MU type feedback may be requested.

In another example, the STA may not be configured with separate feedback types for MU and SU; instead, the STA may be configured with only one type feedback. For example, SU type feedback and MU type feedback can be combined into a single feedback type. In this case, the AP may request only the SNR or CQI feedback, instead of the full beamforming feedback report.

### Example HE Compressed Beamforming Frame Action Field

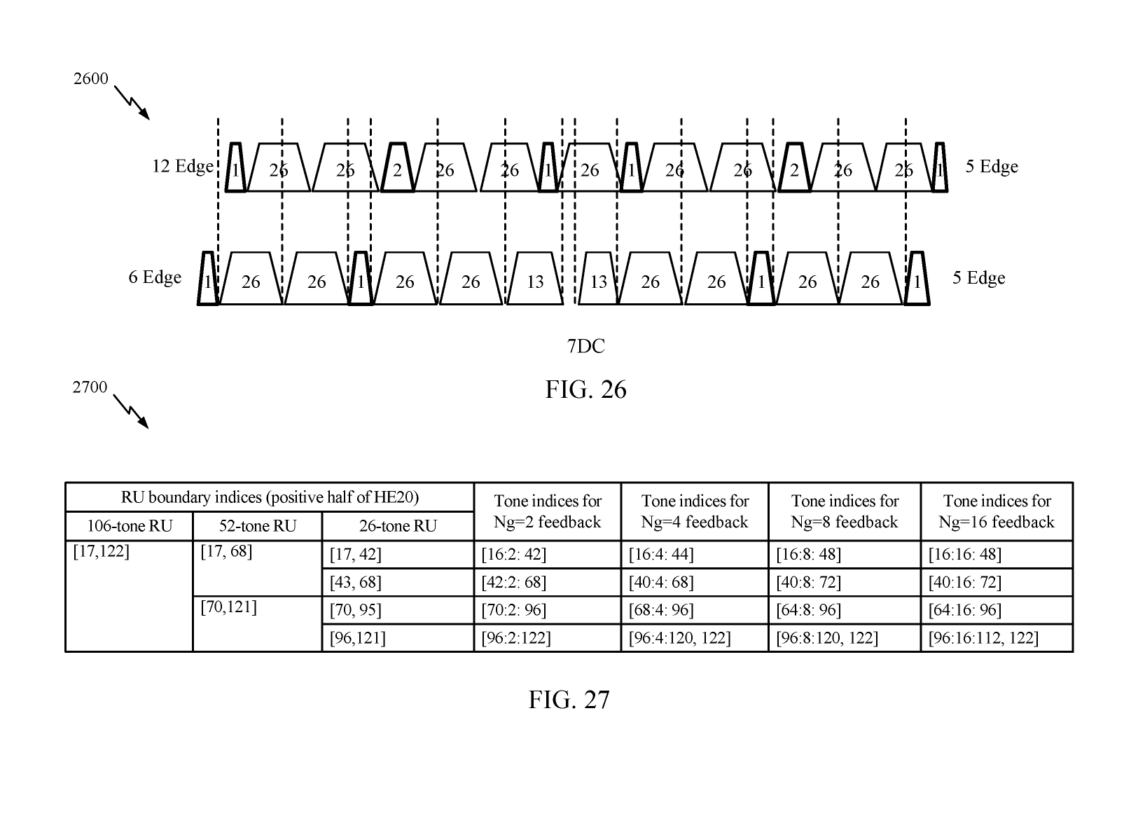

The HE Compressed Beamforming Frame Action field may have Category and HE Action fields in subfields as the first two subfields (e.g., similar to the VHT compressed beamforming frame format shown in FIG. 26), respectively, with values indicating HE and HE compressed beamforming frame. Rather than a VHT MIMO control field, the HE Compressed Beamforming Frame Action field may have an HE MIMO control field, which may reuse all fields in the VHT MIMO control field, except that the remaining feedback segment field and the first feedback segment field may not be present. The remaining feedback segment field and the first feedback segment field may not be included since the HE compressed beamforming frame is for partial bandwidth feedback. The partial bandwidth index (e.g., RU index, subband index, etc.) may be included along with the fed back contents in the succeeding report field(s).

In one example, the HE Compressed Beamforming Frame Action Field may include an SNR Report in the fourth subfield (which may include SNR for all partial bandwidths), HE Compressed Beamforming Spatial Report in the fifth subfield (which may include the V matrix if SU/MU for all requested partial bandwidths), and an MU Exclusive Beamforming Report in the sixth subfield (which may include delta SNR if MU for all requested partial bandwidths). The presence of each field may depend on the type of feedback.

In another example, the HE Compressed Beamforming Frame Action Field may include the SNR Report (e.g., if it is a basic per-stream SNR only type of feedback) or HE Compressed Beamforming Report (e.g., if it is a SU type of feedback) in the fourth subfield and MU Exclusive Beamforming Report in the fifth subfield.

The SNR report may always be present. For each requested partial bandwidth, the SNR report may include the partial bandwidth index (e.g., RU index, subband index) and the per steam SNRs. The HE compressed beamforming spatial report (present in SU or MU types of feedback) may include the partial bandwidth index and the V matrix per feedback tone for each requested partial bandwidth. The MU exclusive beamforming report (only present in the MU type of feedback) may include the partial bandwidth index and delta SNRs per feedback tone for each requested partial bandwidth.

In yet another example, the HE Compressed Beamforming Frame Action Field may include only a single “Type dependent HE beamforming report” field. For each requested partial bandwidth, feedback may include the partial bandwidth index (e.g., RU or subband index), the per-stream SNR, per feedback tone V matrix, and per-stream per feedback tone delta SNRs.

The type dependent HE beamforming report content may depend on the type of feedback. For example, for basic type feedback, this field may include the SNR report; for SU type feedback, this field may include the HE compressed beamforming report; for MU type feedback, this field may include the partial bandwidth index, per stream SNRs, per feedback tone V matrix, and per-stream per feedback tone delta SNR for each requested partial bandwidth.

According to certain aspects, the HE Compressed Frame Action field may include information for the tone-by-tone feedback structure described herein. In one example implementation, the HE Compressed Beamforming Frame Action field may include the HE beamforming report (e.g., in the fourth place), HE MIMO control (e.g., in the third place), HE Action (e.g., in the second place), and Category field (e.g., in the first place). The HE beamforming report may be formed from multiple partial bandwidths. For example, for each requested partial bandwidth, the report may include the partial bandwidth index (e.g., RU index or subband index), per-stream SNRs, per feedback tone V matrix information, and per-stream and per feedback tone delta SNR. In another example implementation, the HE Compressed Beamforming Frame Action field may include the HE beamforming report and delta SNR report in a field (e.g., in the fifth place), the SNR report in a field (e.g., in the fourth place), HE MIMO control field (e.g., in the third place), HE Action field (e.g., in the second place), and Category field (e.g., in the first place). The SNR report field may include per-stream SNR across the NDP bandwidth. The HE beamforming report and delta SNR report field may include per stream delta SNR and V matrix information for each tone.

### Example Sounding Protocol for Partial Band Feedback

In certain systems (e.g., 802.11ax systems), feedback may be supported on part of the NDP bandwidth. According to certain aspects, the AP may request partial bandwidth feedback and the STA(s) may report channel information feedback only for the requested partial bandwidth. Partial bandwidth information may be included in the trigger. For the Beamforming Report structure (e.g., shown in FIG. 23), it may be difficult to extract partial bandwidth information, which may require computing memory offsets to put together the required report. In addition, the average and delta SNRs may be recalculated based on requested frequency segments.

FIG. 25 is a transmission timeline illustrating an example sounding protocol 2500 with feedback on part of the NDP bandwidth, in accordance with certain aspects of the present disclosure. The sounding protocol 2500 may be modified version of the sounding protocol 700 shown in FIG. 7. As shown in FIG. 25, multiple trigger frames may be sent to poll feedback (e.g., each trigger frame soliciting MU feedback back from multiple STAs). As shown in FIG. 25, after sending the NDPA frame and the NDP frame, the AP may send a first trigger frame 2502 to request UL MU feedback, for example rough CSI information (e.g., average per-stream SNR), across the entire or partial bandwidth from the STA 1, STA 2, and STA 3. After receiving the feedback with the rough CSI information, the AP can refine the partial bandwidth feedback request and send a second trigger 2504 to request addition UL MU feedback, for example detailed CSI information (e.g., V matrix and/or per-stream delta SNR of feedback tones), from the STA 1, STA 2 and STA 3.

### Example Feedback Structures

According to certain aspects, a fixed set of feedback indices may be used for each bandwidth, for example, regardless of RU allocation. Different sets of feedback indices may be used for each RU split in the same bandwidth. In RU-based feedback design, the STA may feed back only the tones that fall in the RU being requested, which may lead to an unequal number of feedback tones for the same sized RU, depending upon where the RU is located. Alternatively, feedback structure may be a subband-based modular split and the beamformer may request a certain number of subbands. In another alternative, a new tone-by-tone feedback structure may be used in which the beamformer requests a start tone index and an end tone index.

### Example RU-Based Beamforming Report Units

For RU based feedback, the AP may request feedback for certain RU(s) per STA and the STAs may send feedback just for the requested RUs. For example, for the requested RUs, the STA may send feedback including the RU index, the average per-stream SNR across the RU, the V matrix per tone, and per-stream delta SNR per tone (e.g., if feedback is for MU).

According to certain aspects, complete partial bandwidth request information may be carried in the NDPA frame, and no such information included in the trigger frame. Alternatively, as mentioned above, the trigger frame may carry final partial bandwidth request information. When the final partial bandwidth request information is carried in the trigger frame, the requested partial bandwidth for which feedback is being requested may be known to STA(s) only after the trigger message (e.g., trigger frame) is received. Since the requested partial bandwidth is not known, the STAs may not be able to store channel estimates and, thus, may be read and/or re-calculated from memory. In addition, average and delta SNR may be calculated after reception of the trigger.

In addition, reporting may be inconsistent for different PPDU bandwidths. For example, the beamformed packet may use a PPDU bandwidth that is different than the NDP PPDU bandwidth due to CCA checking.

FIG. 26 illustrates an example tone plan 2600 for channel information feedback, in accordance with aspects of the present disclosure. The NDP PPDU bandwidth may be assumed as HE40, although only the left half is shown in FIG. 26. The beamformed PPDU bandwidth may be HE20 (corresponding to the left half of HE40 shown in FIG. 26) if CCA checking indicates that the right half of HE40 is not available. As shown in FIG. 26, the RU based feedback units based on HE40 may be shifted, for example up to 7 tones, from the beamformed RUs. The sounding packet bandwidth may be restricted the same bandwidth as the transmitted PPDU. Due to null tones, it may be difficult to compose larger RUs from smaller RUs. Also, this pattern may not be friendly to some N_{g} values that are not divisible by 26.

According to certain aspects, RU-based beamforming feedback reporting units may be used.

### Example Subband-Based Feedback Structure

According to certain aspects, a subband based design may be used for feedback. The feedback structure may have an ordering of fields similar to 802.11ac, but structured into subbands. Every subband may be a physical bandwidth, for example, 2.5 MHz, 5 MHz, 10 MHz, or 20 MHz in size. Each subband may include per-stream average SNR, per feedback tone V matrix, and per stream/per feedback tone delta SNR. The STA may estimate the channel and store it in memory. The STA may report channel information feedback only for the subbands being requested, for example, in the trigger. The STA may feedback only average SNR for the requested subbands.

### Example Tone-by-Tone Based Feedback Structure

According to certain aspects, a tone-by-tone based feedback structure may be used. For example, per-stream average SNR may be reported across the NDP bandwidth. V matrix information and per-stream delta SNR may be fed back per tone. The STA may store feedback tone-by-tone and the beamformee may request a certain range of tone indices. SNRs may not be recalculated once the trigger frame arrives. In the tone-by-tone based feedback structure, the feedback reporting can include the per-stream average SNR, and then can be ordered by tone with the V matrix information and the per-stream delta SNR for that tone, for example: V matrix information and per-stream delta SNR for Tone 1, followed by V matrix information and per-stream delta SNR for tone 2, etc.

### Example Modified RU Based Approach

According to certain aspects, a modified RU based approach for feedback may also feedback adjacent null tones for each requested RU. For example, if these tones are populated in the NDP PPDU.

According to certain aspects, a unified approach may be used. The feedback of same N_{g} values for 2×/4×HE-LTFs can be unified, the definition of feedback tones for N_{g}=2, 4, 8 can be unified, and a symmetric definition for positive/negative indexed RUs can be used. This approach may be based on 26-tone RU locations of the NDP PPDU with additional feedback tones. Null tones may be covered and extrapolation of non-feedback tones in the RU can be avoided. All such RUs may be the same size (e.g., 14 tones for N_{g}=2, 8 tones for N_{g}=4; 5 tones for N_{g}=8; and 3 tones for N_{g}=¹⁶), except for the center 26-tone RU in HE20 and HE80. Multiple such RUs feedback could form feedback of larger RUs. For example, 52 or 106 tone RU feedback can be formed from 2 or 4 such RU feedback and 242 tone RU feedback can be formed from 9 such RU feedback (e.g., with four tones are DC missing in HE20).

According to certain aspects, in the unified approach, only even index tones that are multiples of N_{g} may be fed back. The number of feedback tones for N_{g} to cover the entire 26 tone RU to avoid extrapolation of feedback may be given by K_N_{g}=ceil(26/N_{g})+1. For example, K_N_{g}=14 for N_{g}=2, K_N_{g}=8 for N_{g}=4, K_N_{g}=5 for N_{g}=8, K_N_{g}=3 for N_{g}=16. An exception is the center 26-tone RU in HE20 and HE80.

For N_{g}=2, 4, 8, if a 26 tone RU in the NDP PPDU has boundary tone indices [N1,N2], where N2=N1+25 and N1>0, the feedback tones can be defined by kN_{g}, (k+1) N_{g}, . . . , (k+K_N_{g}−1) N_{g}, where k N_{g}≦N1 and N2≦(k+K_N_{g}−1) N_{g}. Thus, the number of tones for feedback can be given by ceil ((N1+25)/N_{g}−K_N_{g}+1)≦k≦floor(N1/N_{g}), and finally, k is determined by k=floor(N1/Ng). If the 26 tone RU has boundary tone indices [−N2,−N1], where N1>0, the feedback tones can be defined by −(k+K_N_{g}−1)N_{g}, . . . −(k+1) N_{g}, −k N_{g}. For N_{g}=16, [8 k:16:8(k+4)] can be used where k=floor(N1/8) for an RU in the positive half, and [−8(k+4):16:−8 k] for an RU in the negative half.

According to certain aspects, there are exceptions for central and/or edge RUs. For example, if feedback tones may not be populated, they can replaced by edge tones. For example, for N_{g}=4 in HE40, the edge RU with indices [96,121] may use feedback tones [96:4:120,122], since 122 is the edge tone and tone index 124 is not populated in NDP LTFs of HE20. In another example, tones at the edge may be covered. For example, for N_{g}=4 in HE40, the edge RU with indices [4,29] may use feedback tones [4:4:32] or [3,4:4:28] (e.g., if 4×LTFs is used in NDP) to cover edge tone +3 (could be used in forming feedback for a 242 tone RU). In yet another example, the central 26-tone RU in HE20 and HE80 may be formed by two 13 tone splits. For example, [−16: N_{g}:−4,4: N_{g}:16] may be used for N_{g}=2 and/or 4; [−16, −8, −4, 4, 8, 16] (6 tones) may be used for N_{g}=8; and [−16, −4, 4, 16] (4 tones) may be used for N_{g}=16.

FIG. 27 is a table 2700 showing RUs with contiguous tones in positive half of HE20, in accordance with certain aspects of the present disclosure. As shown in FIG. 31, for central 26 tone RU with two 13 tone splits with boundaries [−16,−4] and [4, 16] can be formed: [−16:2:−4,4:2:16] for N_{g}=2; [−16:4:−4,4:4:16] for N_{g}=4; [−16, −8, −4, 4, 8, 16] for N_{g}=8; and [46, −4, 4, 16] for N_{g}=16. For a 242 tone RU in HE20 with boundary [−122,−2] and [2,122], [−122,−4] and [4,122] can be covered by all RUs feedback. Instead, bandwidth feedback may be requested.

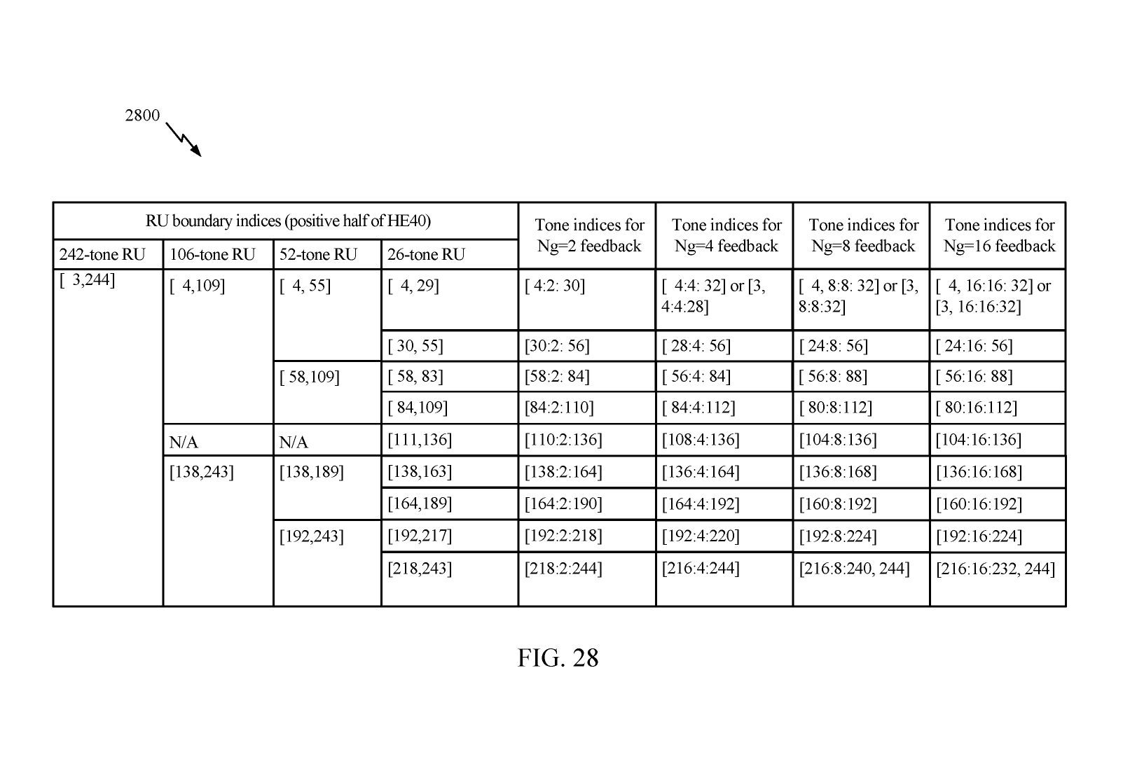

FIG. 28 is table showing an example tone plan 2800 with RUs having contiguous tones in positive half of HE40, in accordance with certain aspects of the present disclosure. All RU sizes may be covered.

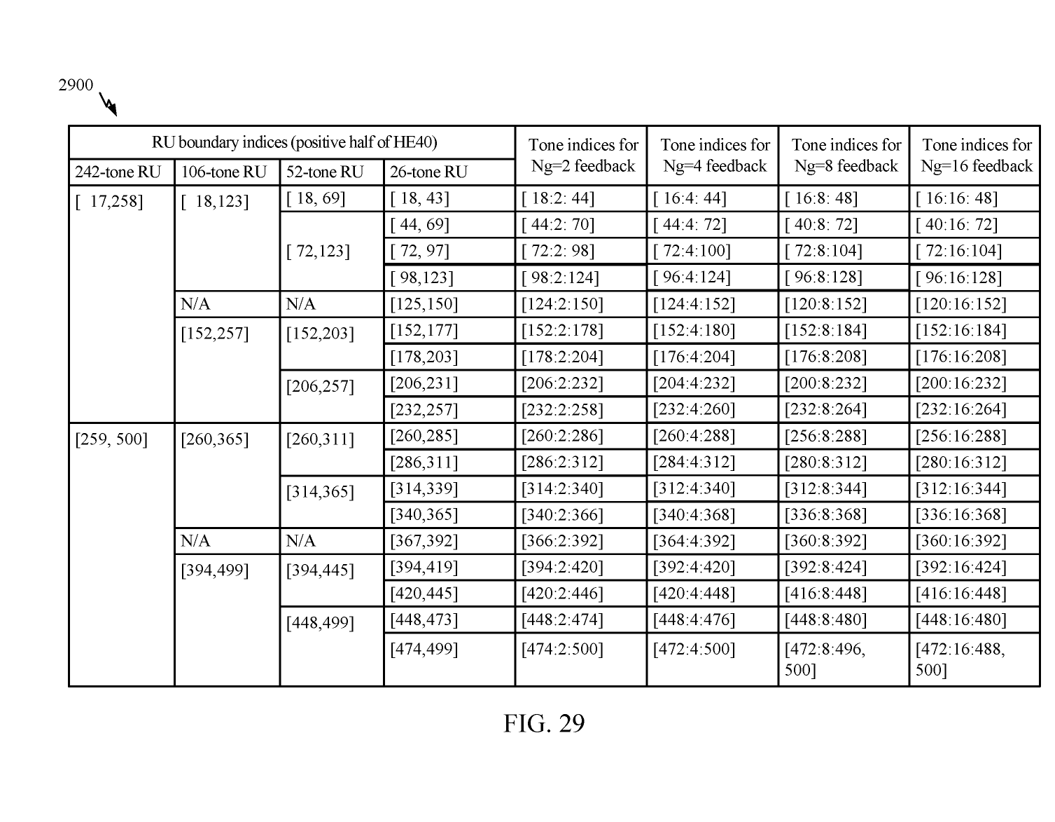

FIG. 29 is table showing an example tone plan 2900 with RUs having contiguous tones in positive half of HE80, in accordance with certain aspects of the present disclosure. All RU sizes may be covered. For 996 tone RU with boundaries at [−500,−3] and [3,500], [−500, −4] and [4,500] could be covered by all RUs feedback.

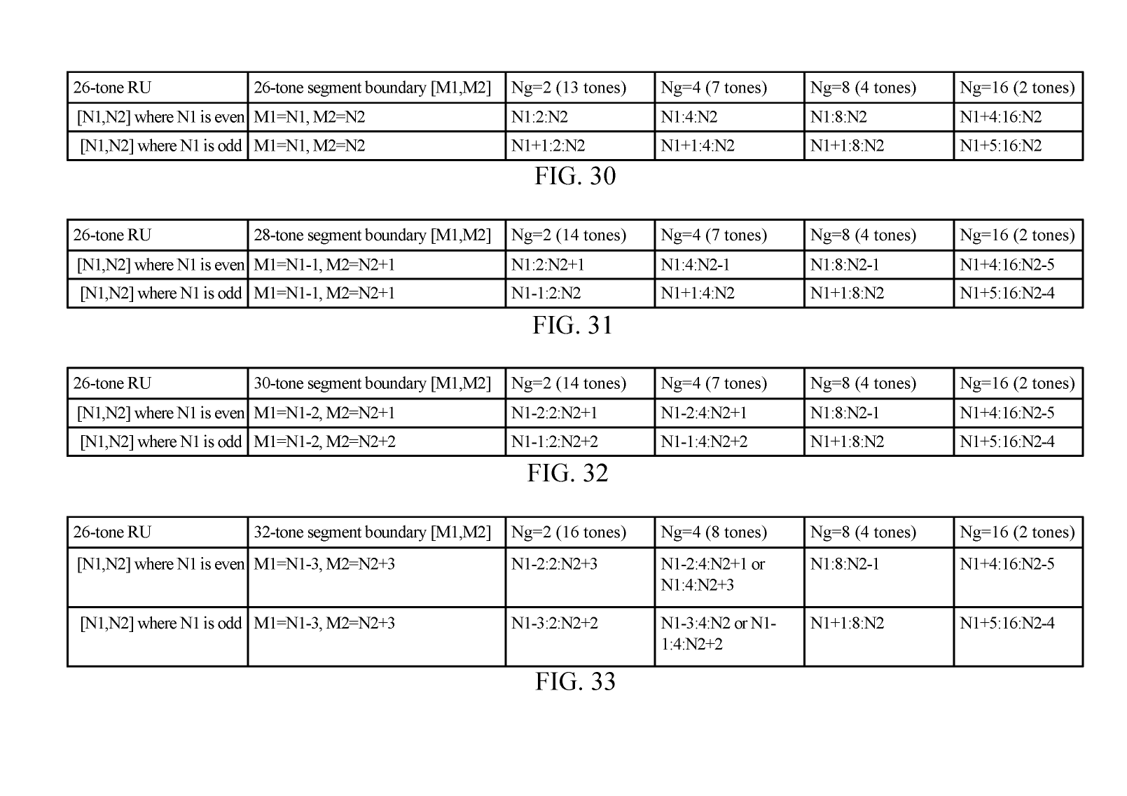

Due to symmetry of tone plans, in some cases only center and positive 26-tone RUs may be considered. According to certain aspects, 3 types of 26-tone RU may be requested: a center 26-tone RU with boundaries [46,4] & [4,16] where if N_{g}=2 [−16:2:−4, 4:2:16] (14 feedback tones) can be used; if N_{g}=4 [−16:4:−4, 4:4:16] (8 feedback tones) can be used; if N_{g}=8, [44, −6, 6, 14] (4 feedback tones) can be used; if N_{g}=16, [−8,8], [40,10], or [42,12] (2 feedback tones) can be used. A 26-tone RU formed by contiguous tones with boundaries [N1,N2], where N1>0 is odd; and a 26-tone RU formed by contiguous tones with boundaries [N1,N2], where N1>0 is even. For the two different center 26-tone RU types, for different N_{g} values (e.g., N_{g}=2, 4, 8, or 16), the feedback may be for a segment [M1,M2] that covers the RU. FIGS. 30-33 are tables showing examples of 26-tone RUs having a 26-tone, 28-tone, 30-tone, and 32-tone segment boundary, respectively.

### Example Single RU Based Beamforming Feedback Reporting Unit

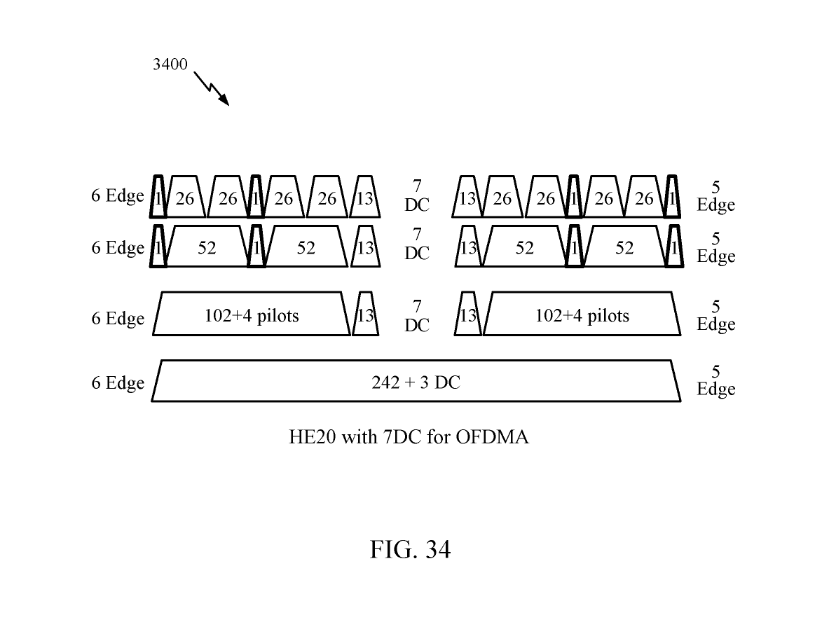

In yet another approach, a single-RU based feedback reporting unit may be used. According to certain aspects, only a single RU feedback may be requested that is a large enough RU to cover the bandwidth of interest. This may avoid feedback of multiple RUs from non-contiguous band in the NDP PPDU and also cover larger bandwidth of interest to avoid shifting of RU location if the beamformed PPDU bandwidth is smaller than the NDP PPDU. The requested RU may have 26, 52, 106, 242, 484, or 996 tones and may have additional feedback for null tones. FIG. 34 illustrates an example tone plan 3400, in accordance with aspects of the present disclosure. In one example, if the AP is interested in the first and third 26 tone RUs in HE20, the AP may request the first 106 tone RU feedback. In another example, if the AP is interested in the fourth and seventh 26 tone RUs in HE20, the AP may request a 242 tone RU feedback.

### Example Pilot Tones in Feedback Tones

In certain systems (e.g., 802.11ac systems), pilot tones may not be used as feedback tones. Pilot tones may be odd indexed. For N_{g}=1 feedback, pilot tones may be skipped. For N_{g}=2 or 4, feedback tones may use even indexed tones.

According to certain aspects, in certain other systems (e.g., 802.11ax systems), pilot tones may be even indexed and may be included in the numerology for feedback tone design for N_{g}=2, 4, 8, 16, for example: 20 MHz: ±22, ±48, ±90, ±11; 40 MHz: ±10, ±36, ±78, ±104, ±144, ±170, ±212, ±238; 80 MHz: ±24, ±92, ±158, ±226, ±266, ±334, ±400, ±468; and 160/80+80 MHz: Each half may use same tone plan as 80 MHz.

Channel estimation (e.g., CSI) for pilot tones may be estimated at the STA by interpolation using adjacent populated tones in NDP LTFs. In one example, pilot tones are used as feedback tones. Alternatively, pilot tones may be skipped in N_{g}=2 feedback, but are still fed back for other N_{g} values.

### Example Tone Grouping

In certain systems (e.g., 802.11ac systems), different but related grouping factors may be used. N_{g} is used as the grouping factor in V matrix feedback (e.g., V matrix of every N_{g} tones are fed back) and 2 N_{g} is used as the grouping factor in delta SNR feedback (e.g., per-stream delta SNR of every 2N_{g} tones are fed back).

According to certain aspects, in certain other systems (e.g., 802.11ax systems), N_{g} may be used as the grouping factor in V matrix feedback. For example, the design for N_{g} value may be used to determine feedback tones. 2N_{g} may be used as the grouping factor in delta SNR feedback. For example, the design for 2N_{g} value may be used to determine feedback tones.

### Example Feedback Design for N_{g}=4 and N_{g}=16

In some cases, N_{g}=4 and N_{g}=16 feedback granularities may be supported for both V matrix and delta SNR (e.g., as opposed to 2N_{g}). According to certain aspects provided herein, feedback may be based on even indexed tones and edge tones, and sub-20 MHz minimum feedback units may be supported as well as larger feedback units. Aspects of the present disclosure provide for feedback unit design as well as feedback tone design for the feedback units.

As mentioned above, feedback unit design may be based on even tones. According to certain aspects, the PPDU bandwidth may be divided into physical subband bandwidths (e.g., BW_fb). In some cases, the bandwidth may be divided into 20 MHz bandwidths or even smaller bandwidths. For example, the bandwidth may be divided into subband bandwidths of 2.5 MHz, 5 MHZ, 10 MHz, or 20 MHz. In one example implementation, the same feedback unit size may be used for all PDDU bandwidths. In another implementation, different feedback units can be used for different PPDU bandwidths. For example, for PPDU bandwidth 20 MHz, BW_fb=5 MHz; for PPDU bandwidth 40 MHz, BW_fb=10 MHz; for PPDU bandwidth 80 MHz, BW_fb=20 MHz, etc. According to certain aspects, the feedback unit can be dynamically indicated.

According to certain aspects, a technique for dividing the PPDU BW is provided herein. The PPDU BW may have index boundaries [−FFT_SIZE/2, FFT_SIZE/2−1] (e.g., FFT_SIZE=256, 512, and 1024 for 20 MHz, 40 MHz, 80 MHz, respectively) and valid tone index boundaries [−K_max, −DC_max] and [DC_max, K_max]. For example, a 20 MHz PPDU BW may have indices [−128, 127] and valid tone indices [−122, −2] and [2, 122]; a 40 MHz PPDU bandwidth may have indices [−256, 255] and valid tone indices [−244, −3] and [3, 244]; and a 80 MHz PPDU bandwidth may have indices [−512, 5122] and valid tone indices [−500, −3] and [3, 500].

For dividing the PPDU bandwidth into feedback units BW_fb, the number of subbands is num_sb=FFT_SIZE/K_fb, with indices 0, 1, . . . num_sb−1, where K_fb is the number of tones per sub-band. In general, the i-th subband has indices −FFT_SIZE/2+i*K_fb+[0:K_fb−1]. The 0th subband has valid indices [−K_max,min{−FFT_SIZE/2+K_fb−1, −DC_max}]. The (num_sb/2−1)th subband has valid indices [max {−K_max, −FFT_SIZE/2+(num_sb/2−1)*K_fb}, −DC_max]. The (num_sb/2)th subband has valid indices [DC_max,min{−FFT_SIZE/2+(num_sb/2+1)*K_fb−1, FFT_SIZE/2−1}]. The last (i.e., (num_sb−1)th) subband has valid indices [max{DC_max, −FFT_SIZE/2+(num_sb−1)*K_fb}, K_max]. Each of the other subbands may have valid indices covering the entire subband. For example, for PPDU BW=20 MHz with BW_fb=2.5 MHz (32 tones), the bandwidth may be divided into 8 subbands with valid index boundaries [−122, −97], [−96, −65], [−64, −33], [−32, −2], [2, 31], [32, 63], [64, 95], and [96, 127]; PPDU bandwidth=20 MHz with BW_fb=5 MHz (64 tones), the bandwidth may divided into 4 subbands with valid index boundaries [−122, −65], [−64, −2], [2, 63], and [64, 127]; and for PPDU bandwidth=20 MHz with BW_fb=10 MHz (128 tones), the bandwidth may divided into 2 subbands with valid index boundaries [−122, −2] and [2, 122].

According to certain aspects, the minimum feedback unit may be the minimum of half of the PPDU bandwidth and 20 MHz. In other words, the minimum feedback unit may be 20 MHz or, if the PPDU bandwidth is smaller than 40 MHz, the feedback unit may be half the PPDU bandwidth. Other units may be multiples of 20 MHz. For example, for a PPDU bandwidth=20 MHz, the minimum feedback unit may be 10 MHz (e.g., covering half tone plan: 121 tones), and other feedback units may 20 MHz (e.g., covering entire tone plan: 242 tones); for a PPDU bandwidth=40 MHz, the minimum feedback unit may be 20 MHz (e.g., covering half tone plan: 242 tones), and other feedback units may be 40 MHz (e.g., covering entire tone plan: 484 tones); for a PPDU BW=80 MHz, the minimum feedback unit may be 20 MHz (e.g., 242 tone RU [−500, −259] and 242 tone RU plus half 13-tone of the center 26-tone RU [−258, −3], [3, 258], 242 tone RU [259,500]), and other feedback units may be 80 MHz (e.g., covering entire tone plan: 996 tones). According to certain aspects, a center 26-tone feedback may be added for the 20 MHz and 80 MHz designs. According to certain aspects, for PPDU bandwidth=80 MHz, the 20 MHz feedback unit may be change to each 242-tone RU and a center 26-tone RU feedback.

According to certain aspects, designs for PPDU bandwidth of 160 MHz may be a duplicate of the two 80 MHz designs discussed above.

### Example 20 MHz Bandwidth Design

For a PPDU bandwidth of 20 MHz, the tone plan may be 242 tones, for example, with boundaries [−122:−2, 2:122]. For N_{g}=4, there may be 62 feedback tones with tone indices that cover edge(s) at [−122:4:−2, 2:4:122]. Alternatively, there may be 64 feedback tones with indices that use multiples of N_{g}=4, for example [−120:4:−4, 4:4:120]+edge ([−122, −2, 2, 122]).

For N_{g}=16, in one example implementation, there may be 18 feedback tones with tone indices that cover edge(s) at [−114:16:−2, 2:16:144]+([−122, −2, 2, 122]). In another example implementation, there may be 20 feedback tones) with tone indices that use multiples of 4, for example, [−116:16:−4, 4:16:144]+edge ([−122, 122]). In yet another example implementation, there may be 20 almost evenly spread feedback tones with indices [−118:16:−6, 6:16:118]+edge([−122, −2, 2, 122]). In yet another example implementation, there may be 20 almost evenly spread feedback tones with indices [−120:16:−8, 8:16:120]+edge([−122, −2, 2, 122]). In yet another example implementation, there may be 18 feedback tones with tone indices that cover edge(s) at [−122:16:−10, 10:16:122]+edge([−2, 2]). In yet another example implementation, there may be 18 feedback tones that are multiples of N_{g}=16 at [−112:16:−16,16:16:112]+edge([−122, −2, 2, 122]).

In yet another example implementation, there may be 60 feedback tones that use multiples of N_{g}=4, without edges, for example, at [−120:4:−4, 4:4:120].

### Example 40 MHz Bandwidth Design

For a PPDU bandwidth of 40 MHz, the tone plan may be 484 tones, for example, with boundaries [−244:−3, 3:244]. For N_{g}=4, one example implementation, there may be 124 feedback tones with tone indices that cover edge(s) and use multiple of N_{g}=4 at [−244:4:−4, 4:4:244]+edge([−3, 3]). In another example implementation, there may be 124 feedback tones with tone indices that cover edge(s) and use N_{g}/2=2 plus multiples of N_{g}=4, for example, at [−242:4:−6, 6:4:242]+edge([−244, −3, 3, 244]). According to certain aspects, even tones [−4, 4] may be used instead of [−3, 3], for example: [−242:4:−6, 6:4:242]+edge([−244, −4, 4, 244]).

For N_{g}=16, in one example implementation, there may be 34 feedback tones with tone indices that cover edge(s) at [−244:16:−4, 4:16:244]+edge(s)([−3, 3]). Alternatively, there may be 34 feedback tones with tone indices that use multiples of N_{g}=16 at [−240:16:−16, 16:16:240]+edge([−244, −3, 3, 244]). In another alternative, even tones [−4, 4] may be used instead of odd tones [−3, 3], for example: [−240:16:−16, 16:16:240]+edge([−244, −4, 4, 244]). In another example implementation, there may be 34 feedback tones with tone indices that cover edge(s) and use N_{g}/2=8 plus multiples of N_{g}=16, for example, at [−232:16:−8, 8:16:232]+edge([−244, −3, 3, 244]). Alternatively, even tones [−4, 4] may be used instead of odd tones [−3, 3], for example: [−232:16:−8, 8:16:232]+edge([−244, −4, 3, 444]).

### Example 80 MHz Bandwidth Design

For a PPDU bandwidth of 80 MHz, the tone plan may be 996 tones, for example, with boundaries [−500:−3, 3:500]. For N_{g}=4, in one example implementation, there may be 252 feedback tones with tone indices that cover edge(s) and use multiple of N_{g}=4 at [−500:4:−4, 4:4:500]+edge([−3, 3]). In another example implementation, there may be 252 feedback tones with tone indices that cover edge(s) and use N_{g}/2=2 plus multiples of N_{g}=4, for example, at [−498:4:−6, 6:4:498]+edge([−500, −3, 3, 500]). Alternatively, even tones [−4, 4] may be used instead of odd tones [−3, 3], for example: [−498:4:−6, 6:4:498]+edge([−500, −4, 4, 500]).

For N_{g}=16, in one example implementation, there may be 66 feedback tones with tone indices that cover edge(s) at [−500:16:−4, 4:16:500]+edge(s) ([−3,3]). In another example implementation, there may be 66 feedback tones with tone indices that use multiples of N_{g}=16 at [−496:16:−16, 16:16:496]+edge([−500, −3, 3, 500]). Alternatively, even tones [−4, 4] may be used instead of odd tones [−3, 3], for example: [−496:16:−16, 16:16:496]+edge([−500, −4, 4, 500]). In yet another example implementation, there may be 66 feedback tones with tone indices that use N_{g}/2=8 plus multiples of N_{g}=16, for example, at [−488:16:−8, 8:16:488]+edge([−500, −3, 3, 500]). Alternatively, even tones [−4, 4] may be used instead of odd tones [−3, 3], for example: [−488:16:−8, 8:16:488]+edge([−500, −4, 4, 500]).

According to certain aspects, designs for PPDU bandwidth of 160 MHz may be a duplicate of the two 80 MHz designs discussed above.

### Example Feedback Tone Design for Feedback Units

According to certain aspects, for each PPDU bandwidth, for each feedback unit, the feedback tones are the feedback tones in the entire PPDU bandwidth that fall into the unit, plus the two edge tones of the unit (if not already defined as feedback tones). For example, for PPDU bandwidth=20 MHz, with feedback unit BW_fb=2.5 MHz, N_{g}=4, and N_{g}=16, the feedback tone indices may be [−122, −97], where N_{g}=4 uses [−122, −120:4:−100, −97] and N_{g}=16 uses [−122, −112, −97]; [−96, −65] where N_{g}=4 uses [−96:4:−68, −65] and N_{g}=16 uses [−96, −80, −65]; [−64,−33] where N_{g}=4 uses [−64:4:−36, −33] and N_{g}=16 uses [−64, −48, −33]; [−32, −2] where N_{g}=4 uses [−32:4:−4, −2] and N_{g}=16 uses [−32, −16, −2]; [2,31] where N_{g}=4 uses [2, 4:4:28, 31] and N_{g}=16 uses [2, 16, 31]; [32, 63] where N_{g}=4 uses [32:4:60, 63] and N_{g}=16 uses [32, 48, 63]; [64, 95] where N_{g}=4 uses [64:4:92, 95] and N_{g}=16 uses [64, 80, 95]; [96, 127]:N_{g}=4 uses [96:4:120, 122]; N_{g}=16 uses [96, 112, 122].

For PPDU bandwidth=40 MHz, with feedback units BW_fb=20 MHz (e.g., half tone plan), with N_{g}=4 and N_{g}=16, the feedback tone indices may be [−244:−3] where N_{g}=4 uses [−244:4:−4, −3] and N_{g}=16 uses [−244, −240:16:−16, −3] and [3:244] where N_{g}=4 uses [3, 4:4:244] and N_{g}=16 uses [3, 16:16:240, 244].

According to certain aspects, if an edge tone is an odd tone, that tone may be replaced by the nearest even tone in the unit. For example, the above examples can be changed to the following: for PPDU bandwidth=20 MHz, with feedback unit BW_fb=2.5 MHz, N_{g}=4, and N_{g}=16, the feedback tone indices may be [−122, −97], where N_{g}=4 uses [−122, −120:4:−100, −98] and N_{g}=16 uses [−122, −112, −98]; [−96,−65] where N_{g}=4 uses [−96:4:−68, −66] and N_{g}=16 uses [−96, −80, −66]; [−64,−33] where N_{g}=4 uses [−64:4:−36, −34] and N_{g}=16 uses [−64, −48, −34]; [−32, −2] where N_{g}=4 uses [−32:4:−4, −2] and N_{g}=16 uses [−32, −16, −2]; [2, 31] where N_{g}=4 uses [2, 4:4:28, 30] and N_{g}=16 uses [2, 16, 30]; [32, 63] where N_{g}=4 uses [32:4:60, 62] and N_{g}=16 uses [32, 48, 62]; [64, 95] where N_{g}=4 uses [64:4:92, 94] and N_{g}=16 uses [64, 80, 94]; [96, 127]:N_{g}=4 uses [96:4:120, 122]; N_{g}=16 uses [96, 112, 122]. And for PPDU bandwidth=40 MHz, with feedback units BW_fb=20 MHz (e.g., half tone plan), with N_{g}=4 and N_{g}=16, the feedback tone indices may be [−244:−3] where N_{g}=4 uses [−244:4:−4, −4] and N_{g}=16 uses [−244, −240:16:−16, −4] and [3:244] where N_{g}=4 uses [4, 4:4:244] and N_{g}=16 uses [4, 16:16:240, 244].

According to certain aspects, for any of the above described feedback designs, edge tones that are odd tones may be excluded (e.g., not used) as feedback tones. Instead, in an implementation, only even indexed edge tones may be used as feedback tones.

According to certain aspects, for any of the above described feedback tone designs for feedback units, only the feedback tones defined in the tone plan may be used as feedback tones; edge tones of the feedback unit may be excluded (e.g., not used) as feedback tones.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for receiving and means for obtaining may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting and means for outputting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for generating and means for determining may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for determining a period that at least one second apparatus is scheduled to be awake, instructions for generating a first frame for transmission to the second apparatus during the period, instructions for outputting the first frame for transmission, instructions for obtaining a second frame in response to the first frame, instructions for determining ranging information based on a time difference between transmission of the first frame and receipt of the second frame, instructions for generate a third frame including the ranging information, and instructions for outputting the third frame for transmission. In another example, instructions for determining a period to awake from a low power state, instructions for obtaining a first frame from a second apparatus during the period, instructions for generating a second frame for transmission to the second apparatus in response to the first frame, instructions for outputting the second frame for transmission to the second apparatus, instructions for obtaining a third frame comprising ranging information, determined by the second apparatus, based on a time difference between transmission of the first frame and receipt of the second frame, and instructions for determining a relative location of the second apparatus to the first apparatus based on a third frame.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a memory; and
at least one processor coupled with the memory and configured to:
generate one or more frames, collectively having one or more training fields allowing one or more stations to calculate channel information and an indication of one or more feedback parameters for the one or more stations to use for generating the channel information;
transmit the one or more frames; and
receive channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

2. The apparatus of claim 1, wherein the one or more frames comprises one or more announcements frames.

3. The apparatus of claim 2, wherein the one or more announcement frames comprise at least one of: null data packet announcement (NDPA) frames or high efficiency (HE) NDPA frames.

4. The apparatus of claim 3, wherein:
the indication of the one or more feedback parameters comprises an indication of frequency resources to use for the feedback; and
the indication is provided in the NDPA frame.

5. The apparatus of claim 3, wherein:
the indication of the one or more feedback parameters comprises an indication that channel quality information (CSI) only feedback is requested for the feedback; and
the indication is provided in the NDPA frame.

6. The apparatus of claim 5, wherein the CSI only feedback comprises per-stream and per resource unit signal to noise ratio (SNR).

7. The apparatus of claim 5, wherein the indication is provided via a two bit field in the one or more frames.

8. The apparatus of claim 2, wherein the one or more announcement frames are addressed to a plurality of stations.

9. The apparatus of claim 8, wherein the at least one processor is further configured to:
transmit a trigger frame to solicit the channel information feedback, wherein the feedback comprises multi-user (MU) feedback.

10. The apparatus of claim 8, wherein the indication of the one or more feedback parameters indicates at least one of: a subsampling factor for a corresponding reporting unit, an indication of at least one quantization parameter indicating a number of bits to use for channel information feedback, or a number of columns for compressed beamforming matrix information.

11. The apparatus of claim 8, wherein the channel information feedback comprises, for each requested bandwidth, per-stream average signal to noise ratio (SNR), per-tone compressed beamforming matrix information, and per-tone and per-stream delta SNR.

12. The apparatus of claim 2, wherein the one or more announcement frames are addressed to a single station.

13. The apparatus of claim 12, wherein the one or more announcement frames solicit channel information feedback from the station, and wherein the feedback comprises single-user (SU) feedback.

14. The apparatus of claim 12, wherein the channel information feedback is generated based on at least one parameter selected by the station comprising: a subsampling factor for a corresponding reporting unit, an indication of at least one quantization parameter indicating a number of bits to use for channel information feedback, or a number of column for compressed beamforming matrix information.

15. The apparatus of claim 12, wherein the channel information feedback comprises, for each requested bandwidth, per-stream average signal to noise ratio (SNR) and per-tone compressed beamforming matrix information.

16. The apparatus of claim 1, wherein the at least one processor is further configured to:
receive an indication from the at least one or more stations of a maximum number of columns the one or more one stations are capable of generating for a compressed beamforming matrix; and
select the number of columns to indicate for the compressed beamforming matrix based on the indication received from the at least one station.

17. The apparatus of claim 16, wherein maximum of columns indicated is greater than three.

18. The apparatus of claim 1, wherein the indication of one or more feedback parameters indicates a bandwidth for each station to use for feeding back the channel information.

19. The apparatus of claim 18, wherein the reporting unit corresponds to one or more subbands of the indicated bandwidth.

20. The apparatus of claim 19, wherein the one or more subbands comprise at least one of 2.5 MHz, 5 MHz, 10 MHz, or 20 MHz subbands.

21. The apparatus of claim 1, wherein:
the indication of one or more feedback parameters indicates a subsampling factor of at least two; and
the channel information is generated based, at least in part, on the indicated subsampling factor for a corresponding reporting unit.

22. The apparatus of claim 21, wherein the subsampling factor is four or sixteen.

23. The apparatus of claim 22, wherein the system bandwidth is 20 MHz, and wherein the feedback is received on tones [−120:4:−4, 4:4:120].

24. The apparatus of claim 22, wherein:
the system bandwidth is 40 MHz;
the subsampling factor is four; and
the feedback is received on tones [−244:4:−4, 4:4:244].

25. The apparatus of claim 22, wherein:
the system bandwidth is 80 MHz;
the subsampling factor is four; and
the feedback is received on tones [−500:4:−4, 4:4:500].

26. The apparatus of claim 22, wherein:
the system bandwidth is 40 MHz;
the subsampling factor is 16; and
the feedback is received on tones [−244:16:−4, 4:16:244].

27. The apparatus of claim 22, wherein:
the system bandwidth is 80 MHz;
the subsampling factor is 16; and
the feedback is received on tones [−500:16:−4, 4:16:500].

28. The apparatus of claim 22, wherein the indication of the one or more parameters comprises a bit indicating the subsampling factor to be used for the feedback.

29. The apparatus of claim 1, wherein the indication of one or more feedback parameters indicates 26-tone resource units (RUs); and a starting tone index and an ending tone index for each device to use for feeding back the channel information.

30. The apparatus of claim 29, wherein:
7 bits are used to indicate the starting and ending tone index; and
partial bandwidth feedback is requested.

31. The apparatus of claim 1, wherein:
the indication of one or more feedback parameters indicates at least one partial bandwidth for which feedback is requested; and
the received channel information feedback comprises channel information for the indicated partial bandwidth from at least one of the stations calculated based on the one or more training fields.

32. The apparatus of claim 1, wherein the indication of the one or more parameters comprises an indication whether single-user (SU), multi-user (MU), or channel quality information (CQI) only feedback is requested.

33. The apparatus of claim 1, wherein the channel information is received in a frame having a field comprising compressed beamforming matrix information for one or more tones and having an MU Exclusive Beamforming report field comprising delta SNRs for the one or more tones.

34. A method for wireless communications, comprising:
generating one or more frames, collectively having one or more training fields allowing one or more stations to calculate channel information and an indication of one or more feedback parameters for the one or more stations to use for generating the channel information;
transmitting the one or more frames; and
receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

35. The method of claim 34, wherein:
the one or more frames are addressed to a plurality of stations; and
the method further comprises transmitting at least one trigger frame to solicit multi-user (MU) channel information feedback from the plurality of stations.

36. The method of claim 34, wherein:
the indication of one or more feedback parameters indicates a subsampling factor of four or sixteen; and
the channel information is generated based, at least in part, on the indicated subsampling factor for a corresponding reporting unit.

37. The method of claim 34, wherein:
the indication of one or more feedback parameters indicate a 26-tone resource units (RU) and a starting tone index and an ending tone index for the RU for each device to use for feeding back the channel information.

38. The method of claim 34, wherein:
the indication of one or more feedback parameters indicates at least one partial bandwidth for which feedback is requested; and
the received channel information feedback comprises channel information for the indicated partial bandwidth from at least one of the stations calculated based on the one or more training fields.

39. An apparatus for wireless communications, comprising:
means for generating one or more frames, collectively having one or more training fields allowing one or more stations to calculate channel information and an indication of one or more feedback parameters for the one or more stations to use for generating the channel information;
means for transmitting the one or more frames; and
means for receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.

40. A computer readable medium having computer executable code stored thereon for wireless communications, comprising:
code for generating one or more frames, collectively having one or more training fields allowing one or more stations to calculate channel information and an indication of one or more feedback parameters for the one or more stations to use for generating the channel information;
code for transmitting the one or more frames; and
code for receiving channel information from at least one of the stations calculated, in accordance with the one or more feedback parameters, for a corresponding one or more reporting units based on the one or more training fields, wherein the channel information is received via a report containing a plurality of channel information parameters for each of the one or more reporting units.
